(19) United States
(12) Patent Application Publication
(10) Pub. No.: US 2010/0194579 A1
(43) Pub. Date: Aug. 5, 2010

(54) CONTAINER SECURITY DEVICE, CONTAINER SECURITY SYSTEM, AND SECURITY MANAGEMENT METHOD

(75) Inventors: Hyung Rim Choi, Dongnae-gu (KR); Jae Joong Kim, Saha-gu (KR); Jae Kee Lee, Haeundae-gu (KR); Soon Goo Hong, Saha-gu (KR); Chae Soo Kim, Seo-gu (KR); Gwang Hoon Kwark, Busanjin-gu (KR); Gang Bae Lee, Haeundae-gu (KR); Moon Hong Kang, Saha-gu (KR); Joong Jo Shin, Buk-gu (KR); Jae Ik Lee, Sasang-gu (KR); Hee Yoon Kim, Geumjeong-gu (KR); Eun Kyu Lee, Sasang-gu (KR); Jung Rock Son, Dongnae-gu (KR)

Correspondence Address: SHERR & VAUGHN, PLLC, 620 HERNDON PARKWAY, SUITE 320, HERNDON, VA, 20170, US

(73) Assignee: Dong-A University Industry-University Cooperation Foundation, Saha-gu (KR)

(21) Appl. No.: 12/634,482

(22) Filed: Dec. 9, 2009

(30) Foreign Application Priority Data
Feb. 2, 2009 (KR) 1020090007953
Feb. 17, 2009 (KR) 1020090012930

(51) Int. Cl. G08B 21/00

(52) U.S. Cl. 340/686.6

(57) ABSTRACT

Provided are a container security device, a container security system, and a security management method which efficiently check opening/closing of a container door and an opening/closing record of the container door and process seal information, cargo state information, base passing information, and location tracking information in real-time from a gate-out process from a shipper (POA) to a gate-in process to a consignee (POD). The container security system includes the container security device which includes a first communication means for providing container seal information through multi-channel communication; and a second communication means for providing information about container transportation and storage in real-time.

### CROSS-REFERENCE TO RELATED PATENT APPLICATION

This application claims the benefit of Korean Patent Application No. 10-2009-0007953, filed on Feb. 2, 2009, and 10-2009-0012930, filed on Feb. 17, 2009, in the Korean Intellectual Property Office, the disclosure of which is incorporated herein in its entirety by reference.

### BACKGROUND OF THE INVENTION

1. Field of the Invention

The present invention relates to container security, and more particularly, to a container security device, a container security system, and a security management method which efficiently check opening/closing of a container door and an opening/closing record of the container door and process seal information, cargo state information, base passing information, and location tracking information in real-time from a gate-out process from a shipper (POA) to a gate-in process to a consignee (POD).

2. Description of the Related Art

Safety is very important in the cargo transportation industry. Cargo transportation companies and their customers are continuously concerned about missing goods from cargo containers, shipping containers, railway vehicles, trailers, or transport containers used to store and transport goods. Also, cargo transportation companies and government organizations monitor prohibited and harmful goods such as drugs or weapons of mass destruction that are illegally taken in through transport containers, or illegal immigrants.

As a result, cargo transportation companies and government organizations periodically use safety devices such as locks, plastic and metal roof seal, cable seal, bolt seal, safety tapes, safety tags for tracking transport containers, memory buttons, and temperature monitors as a part of all efforts to prevent illegal access to the transport containers.

Most of goods shipped worldwide are shipped and transported by using intermodal cargo containers. International organization for standardization (ISO) dry intermodal containers are well known as generalized intermodal cargo containers.

These containers satisfy a specific standard, a technical standard, or other standards set by ISO and thus are used to facilitate international trade, in particular, to promote use and development of compatible standardized containers for various transportation means such as container handling equipments, deep-sea vessels, railway equipments, and over-the-road equipments.

FIG. 1 is a view illustrating a transportation flow for a general intermodal cargo container.

A container transportation includes cargo stuffing, truck transportation, gate-in, shipping, navigation, unshipping, gate-out, truck transport, and unloading so that a cargo transportation is accomplished.

That is, containers stuffed with cargo in a cargo stuffing stage pass through an express highway or a railway transport means and are transported to a loading port. The containers transported to the loading port are in the gate of a loading and unloading port such as an unloading field for shipping.

Then, the containers are shipped by using a transport device, the shipped containers are transported to an unshipping port by a container transport ship, and the transported containers are unshipped. The unshipped containers are out of the gate from an unshipping port through a transport means such as a truck.

The gate-out containers pass through an express highway or railway transport means and are unloaded at a desired place by a consignee. It is difficult for customers, cargo transportation companies, and government organizations to monitor security and states of containers which pass through various transport processes.

A current container design may not provide a mechanism for monitoring safety of containers and contents therein. Also, in general containers, plastic or metal “seal” or conventional bolt barrier “seal” as one or more door hasp mechanisms is used to lock the doors of the containers.

The door hasps that are generally used may be easily broken down if holes are made through bolts attached to the door hasps. Also, currently used conventional seal may be easily broken down by using cutting tools and may be replaced with easily copied seal.

Moreover, in “electronic seal” that has been introduced as an improved method, a limited safety function may be only performed due to the limitation of communication distance and the difference in communication network establishment while passing through various areas.

When the electronic seal is installed outside of the containers, the electronic seal may be damaged by outsiders and when the electronic seal is installed inside of the container, a communication environment between a sealing device and an external reader may be deteriorated.

Accordingly, a container security device, which is not affected by a change of container sizes, which is resistant from an external shock, and which smoothly communicates with the outside regardless of a loading environment, is being required.

Requirements in a current container security system are as follows.

In the United States where containers are mainly used in a cargo transportation, a container security system that is more strengthened by SAFE Port Act is required and container safety and security regulation are strengthening due to a Container Security Initiative (CSI) agreement in July, 2007.

Accordingly, container sealing records from a shipper to a consignee, records on temperature/humidity/shock/illuminance for checking inside state of containers, real-time base passing information, and location tracking information may be required.

Also, customers' demands are changing from the cost reduction aspect to the good service aspect such as safety cargo transportation, tracking state/location of cargo, and rapid customs.

However, it is difficult for the current container security system to provide the container sealing records from a shipper to a consignee and providing the real-time base passing information and location tracking information is limited.

In addition, although a communication environment used to provide the container sealing records, the real-time base passing information, and location tracking information has rapidly developed, a security system positively using such a communication environment has not been provided.

Moreover, a container security system, which is compatible with various standards in transport environments, communication environments, and container security environments varied according to countries and service providers, has not been provided.

### SUMMARY OF THE INVENTION

The present invention provides a container security device which is easily installed inside of a container and senses opening/closing of a container door.

The present invention also provides a container security device which is not affected by a change of a container size, which is resistant from an external shock, and which smoothly communicates with the outside regardless of a loading environment.

The present invention also provides a container security device in which a body module is fixed inside of a container and an antenna for a wireless communication is positioned outside of a container through a cable so as to efficiently check opening/closing of a container door and an opening/closing record of the container door.

The present invention also provides a container security device in which a body module is fixed inside of a container so as to completely prevent a breakdown of the container security device caused by outsiders.

The present invention also provides a security system and a security management method which process seal information, cargo state information, base passing information, and location tracking information in real-time from a gate-out process from a shipper (POA) to a gate-in process to a consignee (POD).

The present invention also provides a container security system and a security management method which are compatible for a strengthened container security standard and various other container security standards each having different system.

The present invention also provides a container security system and a security management method which positively use a rapidly developed communication environment by supporting 2.4 GHz/433 MHz dual band communication during transmitting and receiving container security information.

The present invention also provides a container security system and a security management method which strengthen not only safety of cargo but also characteristics of tracking state/location of cargo and thus satisfy standards required by each country so as to accomplish rapid customs and to expand goods for transportation.

The present invention also provides a container security system and a security management method in which an Ad-hoc module (802.15.4) is applied so as to provide a state of cargo in ground transportation and in a yard/ship in real-time.

According to an aspect of the present invention, there is provided container security device including: a body part installed at a combined part of a wall of a container body and a container door; a sliding part installed to slide to the body part which slides by contacting with the container door or the container wall according to opening/closing of the container door; an elastic part which elastically supports the sliding part with respect to the body part; and a motion sensing means which senses movement of the sliding part.

The body part may be attached to the edge of the container door or to the edge of the container body. The sliding part may include a bar, in which one end thereof is supported by elastic part and the other end thereof is projected by a predetermined length toward the outside of the body part, and slide along a sliding guide formed inside of the body part. The motion sensing means may be a micro switch which senses a plurality of hitch protrusions formed at one side of the bar and a hitch of the hitch protrusions so as to sense movement of the sliding part. The motion sensing means may only sense one-way movement in the sliding movement of the sliding part.

The part of the body part may be closely adhered to the container door and a shock sensor may be further included in the part of the body part.

The container security device may further include a temperature and humidity sensor in the part of the body part.

According to another aspect of the present invention, there is provided a container security device including: a body module comprising a sensor and a cable connection terminal, wherein the sensor is formed at one side of a body and is used to sense a container state and the cable connection terminal is formed at the other side of the body; and a connection cable comprising a body connection terminal and an antenna, wherein body connection terminal is formed on one end of the connection cable for connecting with the cable connection terminal of the body module and the antenna is formed on the other side of the connection cable for communicating with the outside, wherein the connection cable is located outside of the container so as to pass through the container door and the container wall, the body module is located inside of the container, and the antennal is located outside of the container.

The sensor included in the body module may be a switch sensor for sensing opening/closing of the container door.

The connection cable may include a light emitting diode (LED) which periodically lights on/off according to opening/closing of the container door.

The body module may include attaching means for attaching the body to the container wall.

The body module may include a main board and the main board may include an interface unit for interfacing with sensors, a microprocessor for controlling operations of the sensors and storing and transmitting information obtained according to the sensing result, a communication module for communicating with an external reader, a memory storing information about a container state and information about the time when the connection cable connected to the body module is broken, a power supplying unit supplying power to each element in the body module, and a timer for checking the opening/closing time of the container door.

The sensors connected through the interface unit may include a switch sensor for sensing opening/closing of the container door and sensors for monitoring various states in the container such as temperature, vibration, radioactivity, gas detection, and movement.

According to another aspect of the present invention, there is provided a container security system including a container security device, wherein the container security device includes: a first communication means for providing container seal information through multi-channel communication; and a second communication means for providing information about container transportation and storage in real-time.

The container security system may further include: a container transportation management server which stores information provided from a container security device and provides a container transportation management service; and base positioned equipments and base mobile equipments which receive information provided from the container security device and transmit the received information to the container transportation management server.

The container security device may provide container seal information, cargo state information, base passing information, and location tracking information in real-time from a gate-out process from a shipper (POA) process to a consignee (POD) process through the first and second communication means.

The first communication means may communicate with a 433 MHz channel or a 2.4 GHz channel and provide container seal information, cargo state information, and base passing information and the second communication means may be an Ad-hoc module for providing cargo state information during inland transportation in real-time (CDMA) and in a yard/ship.

According to another aspect of the present invention, there is provided a container security system including: a security device which provides container seal information, cargo state information, and base passing information through multi-channel communication; an Ad-hoc module which provides cargo state information during inland transportation in real-time and in a yard/ship; a container transportation management server which stores information provided from the security device and the Ad-hoc module and provides a container transportation management service; and base positioned equipments and base mobile equipments which receive information provided from the container security device and the Ad-hoc module and transmit the received information to the container transportation management server.

The container security device and the Ad-hoc module may be attached to the container after cargo is loaded to the container in a shipper (POA) process and removed from the container when the container is entered and the cargo state may be checked in a consignee (POD) process.

The container security device may provide container seal information, cargo state information, and base passing information by using a 433 MHz channel or a 2.4 GHz channel.

The base positioned equipments may include a 433 MHz reader and a 2.4 GHz reader for communicating with the container security device and the base mobile equipments may include a 433 MHz relay device, a 2.4 GHz relay device, a network device (Coordination-Point) which receives information about Ad-hoc modules, and relay nodes of a network bridge.

According to another aspect of the present invention, there is provided a container security management method including: attaching a container security device and an Ad-hoc module to a container in a shipper process where cargo is loaded to the container and delivered, wherein the container security device provides container seal information, cargo state information, and base passing information through multi-channel communication and the Ad-hoc module provides cargo state information in real-time (CDMA) during an inland transportation process and in a yard/shipping, so as to provide container seal information, cargo state information, base passing information, and location tracking information in real-time from the shipper process to a consignees process.

The shipper process may include attaching the container security device and the Ad-hoc module to the container after loading the cargo, generating a cargo profile through a reader, activating the container security device, registering information to DB, and delivering the container.

The activating of the container security device may include: determining whether the cargo profile is set due to a turning-on command of the container security device; when the cargo profile is set, checking a residual quantity of a battery; activating a sealing function and tripping on DB; when closing of the container door is sensed, initiating a container security sensing operation and recording an event log; activating the container security device and setting an event wait state.

The method may further include an inland transportation process performed between the shipper process and the consignee process, wherein the inland transportation process includes identifying container seal information and a cargo profile through a fixed reader installed to a main base of a inland transportation path and transmitting a cargo state and location information through the Ad-hoc module in real-time.

When an event is generated during the inland transportation, the inland transportation may include: recording log information for the event and transmitting the corresponding information through the Ad-hoc module; receiving the transmitted information in a network device (Coordination point) and transmitting the received information by Code Division Multiple Access (CDMA); receiving state information transmitted by CDMA in an operating server and accessing the state information through an application of the container security system.

When base passing is accomplished during the inland transportation, the inland transportation may include: transmitting base passing information from the container security device to a reader installed to the base; reading an event log and transmitting the read event log from the container security device to the reader installed to the base; and transmitting location information and state information received in the reader to the operating server, wherein the location information and the state information received in the operating server are accessed by an application of the container security system.

The method may further include an a port of departure process performed between the shipper process and the consignee process, wherein the port of departure process includes inspecting container seal and cargo state through the reader, checking yard loading and shipping, and transmitting cargo state information in the yard by using the Ad-hoc module.

When a security agent requests an inspection through a PC in the inspecting of the container seal and the cargo state, the inspecting of the container seal and the cargo state may include: requesting a container transportation management server to generate an inspection command; generating the inspection command in the operating server in response to the request; when the inspection command is transmitted from the reader to the container security device, transmitting event log information from the container security device to the reader and receiving coded seal information in the reader; decoding the coded seal information in the operating server, transmitting the decoded information to the container transportation management server, and transmitting the received information to a security agent PC.

When a security agent requests an inspection through the reader in the inspecting of the container seal and the cargo state, the inspecting of the container seal and the cargo state may include: downloading an encryption key managed in the operating server from the reader; reading encryption key data from the reader and generating an inspection command; transmitting event log information from the container security device to the reader due to the generated inspection command; and receiving the coded seal information in the reader, decoding the coded seal information, and outputting an inspection result.

The method may further include a marine transportation process performed between the shipper process and the consignee process, wherein the marine transportation process includes: in order to transmit cargo state information in real-time by using the Ad-hoc module, recording a even log, when an event is generated during the marine transportation, and transmitting the corresponding information from the Ad-hoc module; receiving the information transmitted by the Ad-hoc module in a network device (Coordination point), recording state information through an application for shipping, and accessing the state information; and transmitting selected information from the state information to the operating server through a satellite (INMARSAT).

The method may further include a port of arrival process performed after the shipper process, wherein the port of arrival process includes checking a container seal state through the reader, performing a total inspection, if there is a problem as a result of checking the state, or performing a gate-out process, if there is no problem, and deactivating a container security function.

The consignee process may include checking container seal and cargo state, when the container is entered, turning off the container security device, and removing the container security device from the container.

### BRIEF DESCRIPTION OF THE DRAWINGS

The above and other features and advantages of the present invention will become more apparent by describing in detail exemplary embodiments thereof with reference to the attached drawings in which:

FIG. 1 is a view illustrating a transportation flow for a general intermodal cargo container;

FIG. 2 is a perspective view of a container security device, according to an embodiment of the present invention;

FIGS. 3 and 4 are enlarged views of the container security device of FIG. 2, according to an embodiment of the present invention;

FIGS. 5 and 6 are views of the container security device of FIG. 2 attached to a container, according to an embodiment of the present invention;

FIGS. 7 and 8 are views of the container security device of FIG. 2 attached to a container door and operated, according to an embodiment of the present invention;

FIG. 9 is a view of a body module of a container security device, according to another embodiment of the present invention;

FIGS. 10 and 11 are views respectively illustrating the side and the top of the body module of the container security device of FIG. 9;

FIG. 12 is a view of a connection cable of the container security device of FIG. 9;

FIG. 13 is a block diagram of a body module of a container security device, according to an embodiment of the present invention;

FIG. 14 is view of a communication system using a container security device, according to an embodiment of the present invention;

FIG. 15 is a view illustrating a container cargo transportation process using a container security system and the information process coverage, according to an embodiment of the present invention;

FIG. 16 is a view of a container security system, according to an embodiment of the present invention;

FIGS. 17A and 17B through 17C illustrate a shipper process in a container security system, according to an embodiment of the present invention and are flowcharts illustrating the shipper process, respectively;

FIGS. 18A and 18B through 18C illustrate an inland transportation process of a container security system, according to an embodiment of the present invention and are flowcharts illustrating the inland transportation process, respectively;

FIGS. 19A and 19B through 19D illustrate a port of departure process in a container security system, according to an embodiment of the present invention and are flowcharts illustrating the port of departure process, respectively;

FIGS. 20A and 20B illustrate a marine transportation process in the container security system, according to an embodiment of the present invention and is a flowchart illustrating the marine transportation process, respectively;

FIGS. 21A and 21B illustrate a port of arrival process in the container security system, according to an embodiment of the present invention and is a flowchart illustrating the port of arrival process, respectively; and

FIGS. 22A and 22B illustrate a consignee process in the container security system, according to an embodiment of the present invention and is a flowchart illustrating the consignee process, respectively.

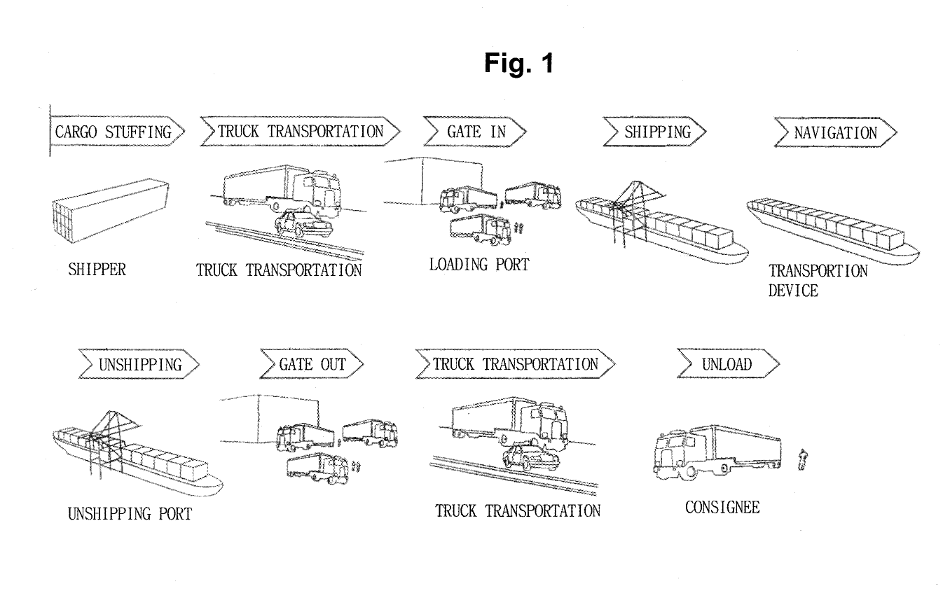

### DETAILED DESCRIPTION OF THE INVENTION

Hereinafter, a container security device, a container security system, and a security management method according to exemplary embodiments of the present invention will be described more fully.

Characteristics and advantages of a container security device, a container security system, and a security management method according to the present invention will be apparent through the detailed description of the invention below.

The present invention relates to a container security device, which is easily installed inside of a container, senses opening/closing of a container door, and completely prevents a breakdown of the container security device caused by outsiders, and a container security system including the container security device.

Also, the present invention relates to a container security management method which may process seal information, cargo state information, base passing information, and location tracking information in real-time from a gate-out process from a shipper (POA) to a gate-in process to a consignee (POD) by using the container security system so as to improve reliability of a cargo transportation.

(Container Security Device According to First Embodiment)

Firstly, a container security device which is easily installed inside of a container and senses opening/closing of a container door is described.

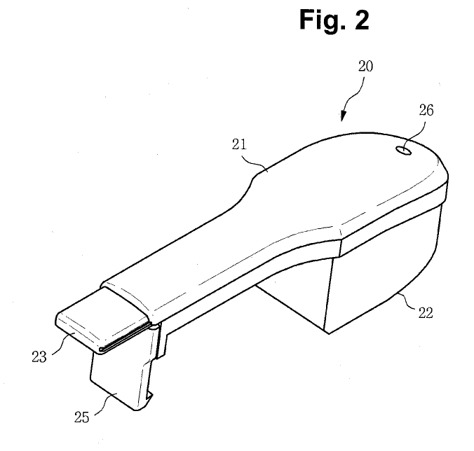

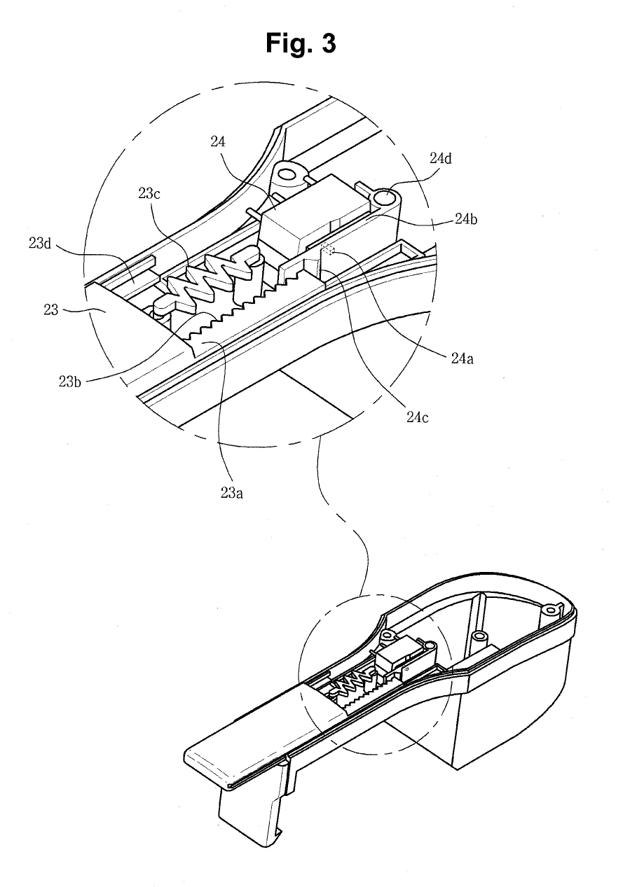

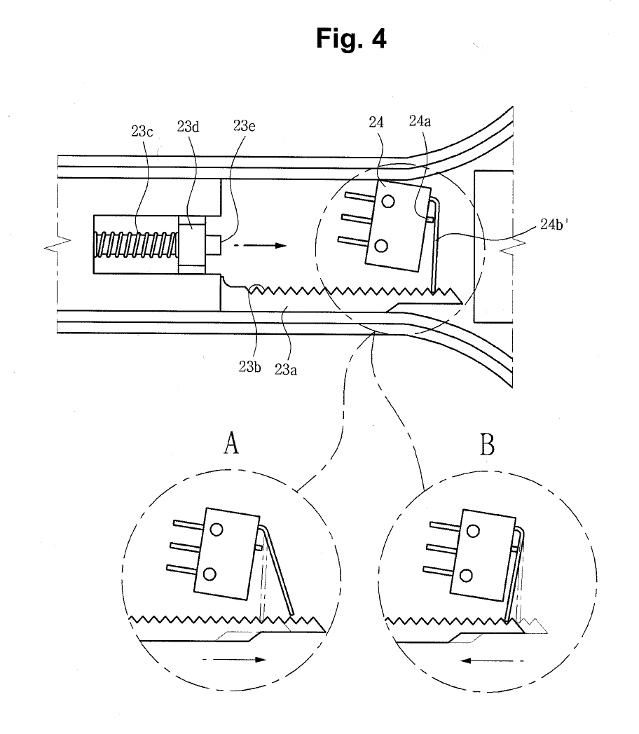

FIG. 2 is a perspective view of a container security device 20, according to an embodiment of the present invention and FIGS. 3 and 4 are enlarged views of the container security device 20 of FIG. 2, according to an embodiment of the present invention.

The container security device 20 according to the current embodiment includes a body part 21, a sliding part 23, a projecting part 25, and various sensors.

The body part 21 is bent in the form of so as to be closely adhered to a projected part of a container door. However, the body part 21 may change the form so as to be adhered to the other part of the container door according to user's selection.

Also, motion sensing means are included in the body part 21 and are described more fully below.

In addition, a shock sensor (not illustrated) and a temperature and humidity sensor 26 are included in the body part 21.

The sliding part 23 slides inside or outside of the body part 21 due to contact with the container door while opening/closing the container door and thus is formed in the form of bar. The inner end of the sliding part 23 is supported by an elastic means and the outer part of the sliding part 23 is partially projected.

The body part 21 includes a guiding part 23d which guides sliding of the sliding part 23.

The projecting part 25 is used to communicate with the outside and includes a communication module (not illustrated) and a controller (not illustrated).

Hereinafter, elements included in the container security device 20, that is, the motion sensing means, are described.

As illustrated in a circle of FIG. 3, the motion sensing means included in the container security device 20 of FIG. 3 include a bar 23a, a plurality of hitch protrusions 23b, a leaf spring 23c, a sensing guide 24b, and a micro switch 24, wherein the bar 23a is extended at one side of the sliding part 23, the plurality of hitch protrusions 23b are in the form of a saw blade and are formed at one side of the bar 23a, the leaf spring 23c is in the zigzag form and elastically supports the bar 23a, and the sensing guide 24b senses a hitch of the hitch protrusions 23b and delivers the hitch to the micro switch 24.

The sensing guide 24b is in the form of board. One side of the sensing guide 24b is combined to a shaft 24d so as to be rolled. A hitch part 24c on which the hitch protrusions 23b are hitched is formed on the side corresponding to the hitch protrusions 23b and an elastic part (not illustrated) which elastically supports the sensing guide 24b is formed on the other side.

Accordingly, when the bar 23a slides, the sensing guide 24b are hitched onto the hitch protrusions 23b and thus are pressed. As such, when the sensing guide 24b is pressed, the sensing guide 24b presses a micro switch pin 24a of the micro switch 24 and thus the micro switch 24 may sense movement of the bar 23a.

Here, intervals of the saw blade form hitch protrusions 23b and sizes of the saw blades are controlled so as to control motion sensing precision of the sliding part 23 and the saw blade form hitch protrusions 23b may be in the form of a cylinder according to selection by a user.

Accordingly, when the motion sensing means including the hitch protrusions 23b and the micro switch 24 is formed, the container security device 20 may be installed even if the distance between a container body 50 and a container door 51 varies in containers, and opening/closing of the container door may be sensed.

In addition, according to user's selection, the motion sensing means may not include the hitch protrusions 23b and the micro switch 24, that is, may include instead a sensor which recognizes a mark after marking at regular intervals on one side of the bar 23a.

Hereinafter, installation and working of the container security device 20 are described.

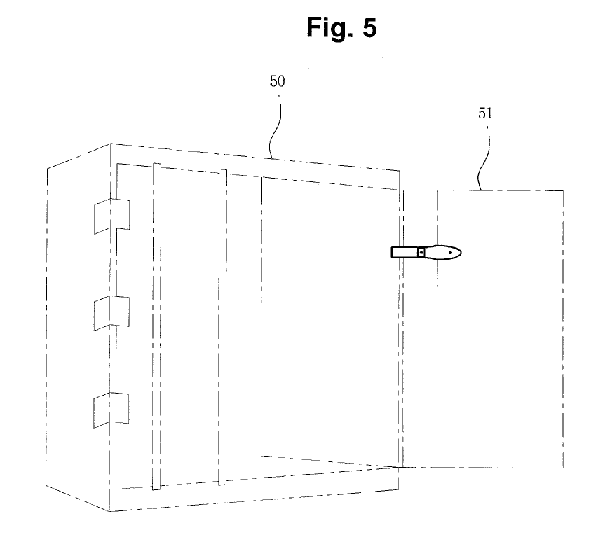

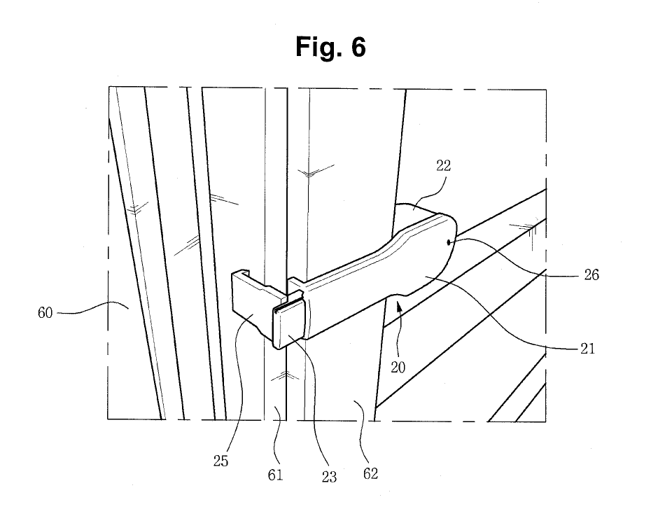

As in FIGS. 5 and 6, the container security device 20 is installed to the inner edge of the container door 51 at a combined part of the wall of the container body 50 and the container door 51.

Here, the container security device 20 is attached to a part 62 projected from the edge of the container door 51. Also, the projecting part 25 including the communication module is inserted to the combined part of the wall of the container body 50 and the container door 51 and one side of the projecting part 25 is closely adhered to a rubber gasket 61.

As such, the projecting part 25 is installed between the combined part of the wall of the container body 50 and the container door 51 so that the container security device 20 is near to the outside and thus may communicate with the outside without a separate antenna.

In addition, the projecting part 25 is installed to the rubber gasket 61. Thus, although the container door 51 is closed, the projecting part 25 is prevented from being damaged by a shock.

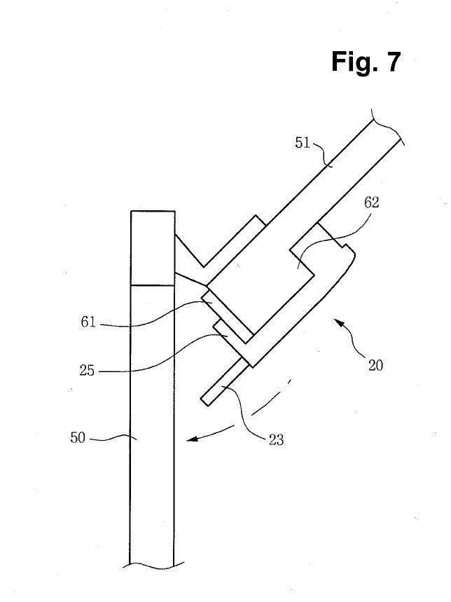

Accordingly, in the container security device 20 installed to the container door 51, the sliding part 23 is opened when the container door 51 is opened, that is, as illustrated in FIG. 7, a part of the sliding part 23 is projected to the outside of the container body 50.

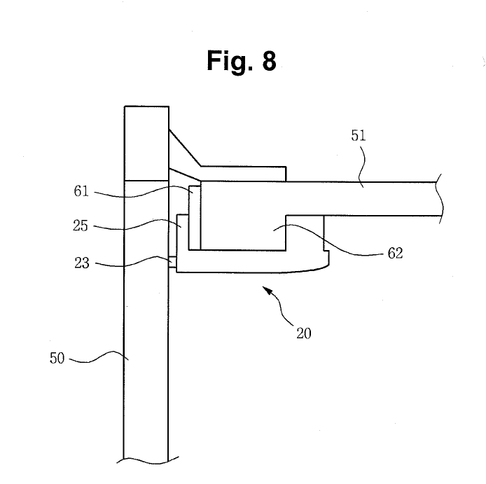

Then, when the container door 51 is closed, the sliding part 23 contacts the wall of the container body 50 and thus is closed by a reaction force. That is, the sliding part 23 is pushed into the container body 50 as illustrated in FIG. 8.

Accordingly, when the sliding part 23 is pushed into the container body 50, the micro switch 24 measures the movement of the sliding part 23 and transmits the measured data to the controller.

Then, when more than a regular value is measured based on the standard when the sliding part 23 is opened, the controller recognizes that the container door 51 is closed. When a change in data does not occur afterward, the controller recognizes that the container door 51 is completely closed.

While the container door 51 is closed, when the container door 51 is opened, the sliding part 23 is opened by the elastic means. That is, the sliding part 23 is pushed out. Here, as described above, the micro switch 24 measures the movement of the sliding part 23 and transmits the measured data to the controller.

Then, when data at a regular level or above is measured according to the measured data, the controller recognizes that the container door 51 is opened. When a change in data does not occur afterward, the controller recognizes that the container door 51 is completely opened.

The container security device 20 further includes the shock sensor (not illustrated) and the temperature and humidity sensor 26, in addition to the motion sensing means.

The shock sensor is included in the part of the body part 21 which is closely adhered to the container door 51 so as to directly sense the case when a door locking device (not illustrated) included in the container door 51 is to be unlocked by applying an external force.

In addition, the temperature and humidity sensor 26 may be included in a part of the outer circumference of the body part 21 so as to well sense temperature and humidity of the inside of the container.

Data measured by the shock sensor and the temperature and humidity sensor 26 is transmitted to the controller and the controller determines a general state of the container by using both data measured by the shock sensor and the temperature and humidity sensor 26 and the data measured by the motion sensing means. The state of the container determined as above is transmitted to the outside through the communication module.

(Container Security Device According to Second Embodiment)

Hereinafter, a container security device according to a second embodiment will be described. Description of elements in the second embodiment that are same with the elements described in the first embodiment will be omitted and only features that are distinguishable from the first embodiment will be described.

The container security device according to the second embodiment has the same structure with that of the first embodiment as illustrated in FIG. 3. However, unlike the first embodiment, the motion sensing means does not include the sensing guide and a location of the micro switch is changed in the motion sensing means.

That is, the motion sensing means included in the container security device 20 includes the bar 23a extended at one side of the sliding part 23, the plurality of hitch protrusions 23b in the form of a saw blade and formed at one side of the bar 23a, an elastic means elastically supporting the bar 23a, and the micro switch 24.

Unlike the first embodiment, the elastic means includes a spring 23c rolled onto a cylinder 23e and an elastic supporting member 23d on which a via hole (not illustrated) is formed, wherein the cylinder 23e penetrates the via hole and the spring 23c hitches in the via hole. Such a structure indicates various examples of elastic means. The elastic means described in the first embodiment may be used and various other elastic means may be used according to the user's selection.

The micro switch 24, which includes a hitch pin 24b′, directly senses a hitch of the hitch protrusions 23b and is installed by being rotated about 90° compared with that of in the first embodiment. Thus, only one-way movement may be measured in the sliding movement of the sliding part 23.

That is, when the bar 23a slides to the inside of the body part 21 as in A of FIG. 4, although the hitch pin 24b′ is hitched onto the hitch protrusions 23b, the hitch pin 24b is pushed to the outside, which is a moving direction of the bar 23a. Accordingly, the micro switch pin 24a of the micro switch 24 is not pressed and thus the micro switch 24 may not sense the movement of the sliding part 23.

However, when the bar 23a slides to the outside of the body part 21 as in B of FIG. 4, the hitch pin 24b′ is hitched onto the hitch protrusions 23b of the bar 23a and is pressed. Accordingly, when the hitch pin 24b′ is pressed, the hitch pin 24b′ presses the micro switch pin 24a and thus the micro switch 24 may sense the movement of the sliding part 23.

When the motion sensing means is included as in above, the container security device 20 may not sense when the container door 51 is closed; however, may sense when the container door 51 is opened while the container door 51 is closed.

If the micro switch 24 senses opening/closing of the container door 51, the micro switch 24 reacts to a slight vibration and thus a sensing error may occur. However, due to the above structure of the motion sensing means, malfunction of the micro switch 24 due to a vibration may be prevented.

(Container Security Device According to Third Embodiment)

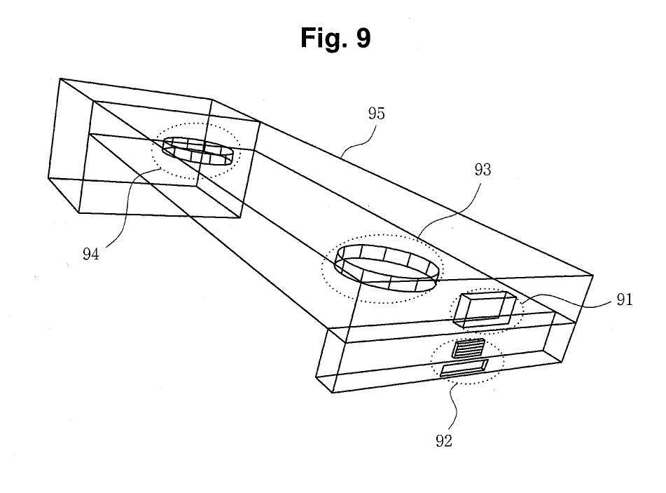

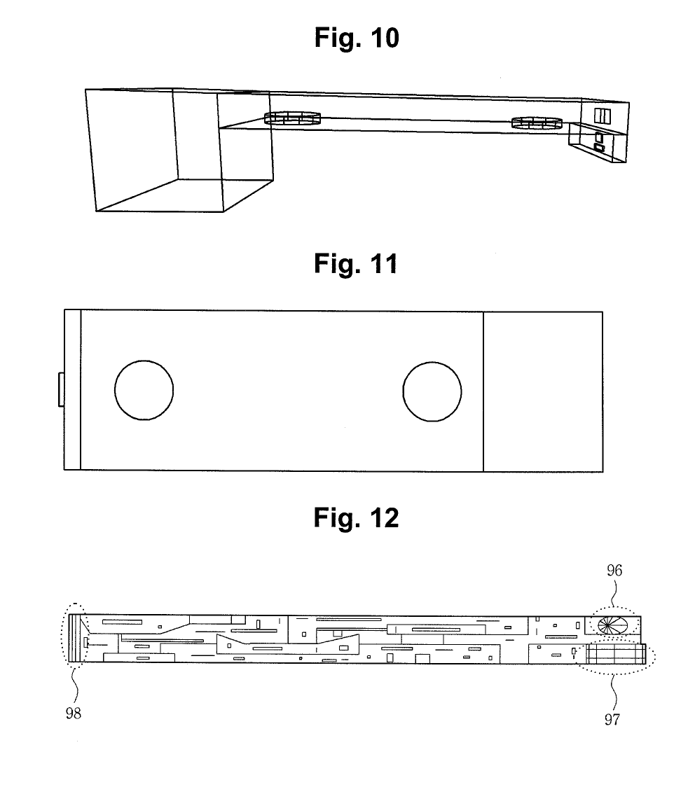

Hereinafter, a switch sensor based container security device according to a third embodiment will be described. FIG. 9 is a view of a body module of the container security device, according to another embodiment of the present invention; FIGS. 10 and 11 are views respectively illustrating the side and the top of the body module of the container security device of FIG. 9; and FIG. 12 is a view of a connection cable of the container security device of FIG. 9.

In the container security device according to the third embodiment of the present invention, the body module is attached to the inside of a container, an antenna for wireless communication is installed to the outside of the container through a cable, and thus opening/closing and opening/closing records of the container door may be efficiently checked.

The container security device is electronic seal which senses opening/closing of the door for security of the container during transferring the container carrying cargo. The container security device includes the body module and the connection cable.

As in FIG. 9, the body module includes a cable connection terminal 92 on one side of a body 95 and attaching means are included in the body 95 for attaching the body 95 to the inner wall of the container. In the current embodiment, magnets 93 and 94 are illustrated as the attaching means. However, the attaching means are not limited to the magnets and may include, for example, a sticker, Velcro tape, mechanical connecting means, or vacuum absorbing means.

In addition, a switch sensor 91 is formed on the one side of the body 95 for sensing opening/closing of the container door.

The connection cable includes a body connection terminal 98, a light emitting diode (LED) 96, and an antenna 97, wherein the body connection terminal 98 is formed on one end of the connection cable for connecting with the cable connection terminal 92 of the body module, and the LED 96, which periodically lights on/off according to opening/closing of the container door, and the antenna 97 for transmitting and receiving container information according to the sensing result of the switch sensor 91 are formed on the other side of the connection cable.

The container security device described above recognizes opening/closing of the container door by using the switch sensor 91.

Also, the connection cable, which is detached from the body module attached to the inside of the container, is used to connect the antenna 97 and the LED 96 so that the antenna 97 and the LED 96 are disposed outside the container.

That is, since the body module is attached to a rotating shaft between the container wall and the container door, the body module is located inside of the container and the connection cable is located outside of the container so as to expose the antenna 97 and the LED 96 to the outside.

As such, since the body module is located inside of the container and the antenna 97 is located outside of the container through the connection cable, the body module is prevented from being broken by outsiders and facilitates communication of container information with the outside.

When the container door is opened after the body module is attached to the container, the distance between the container wall and the container door becomes more distant based on the rotating shaft. The switch sensor 91 of the body module located at the rotating shaft between the container wall and the container door senses opening of the container door.

That is, according to a rotation based on the rotating shaft of the container door, the switch sensor 91 is opened and closed. When the container door is closed, the switch sensor 91 is closed and when the container door is opened, the pressed switch sensor 91 is opened. Thus, the switch sensor 91 senses that the container is opened.

Also, according to opening/closing of the switch sensor 91, information about opening/closing of the container and the time of opening/closing is stored in a memory included in a main board of the body module and the stored information is transmitted to a terminal of a manager (user) through an external reader.

In addition, according to opening/closing of the switch sensor 91, the LED 96 is periodically turned on/off and thus warns the outside opening/closing of the container door.

When the container security system according to the present invention is installed to the container and the connection cable is pulled from the outside for the purpose of stealing or breaking cargo of the container, only connection cable comes off, the body module remains safe, and the time when the connection cable is removed is stored in the memory.

The structure of the body module and an operation when the container security system is actually applied to the container security device are as follows.

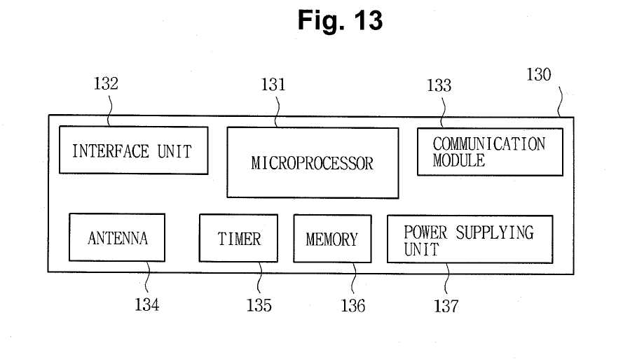

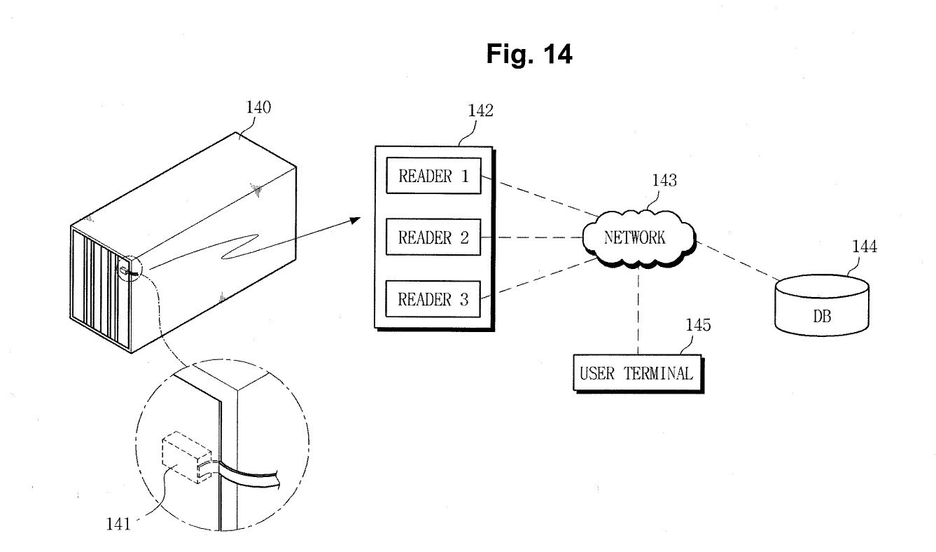

FIG. 13 is a block diagram of the body module of the container security device, according to an embodiment of the present invention and FIG. 14 is view of the communication system using the container security device, according to an embodiment of the present invention.

As illustrated in FIG. 13, a main board 130 included in the body module according to the present invention includes an interface unit 132, a microprocessor 131, a communication module 133, a memory 136, a power supplying unit 137, a timer 135, and an antenna 134, wherein the interface unit 132 is used to interface with a switch sensor, the microprocessor 131 controls an operation of the switch sensor used to sense opening/closing of the container door and store and transmit information obtained according to the sensing result, the communication module 133 is used to communicate with the external reader, the memory 136 stores information about opening/closing of the container door and information about the time when the connection cable is broken, the power supplying unit 137 supplies power to each element in the body module, the timer 135 is used to check the opening/closing time of the container door, and the antenna 134 is connected by the connection cable.

Here, the interface unit 132 is used not only to connect with the switch sensor but also to install additional sensors for monitoring various states in the container such as temperature, vibration, radioactivity, gas detection, and movement.

The microprocessor 131 may be programmed with a code for identifying the container, for example, a container identification code by the International Standards Organization (ISO), as well as Bill-of-Landing (B/L), mechanical seal number, time coding information, and code for identifying readers.

In the container security system described above, when the body module is attached to the inside of the container and opening/closing of the container door is sensed during transporting of the container, such information is transmitted to a terminal of a cargo manager or a user.

A system for transmitting and receiving container information is formed as follows.

As illustrated in FIG. 14, a body module 141 is installed to the inside of the container 140 and a signal transmitted from the body module 141 is received in a reader 142. The received signal is transmitted to a user terminal 145 and a container information storage DB 144 through a network 143.

The container information storage DB 144 stores not only opening/closing records of the container door but also all information needed to transport the container such as shipping records of the container, a shipper and cargo, and transportation records.

Here, if the communication effective range is secured, communication with the user terminal 145 through the body module 141 and the reader 142 may be accomplished by adopting an appropriate technology from among Global System for Mobile Communication (GSM), Code Division Multiple Access (CDMA), Time Division Multiple Access (TDMA), Pacific Digital Cellular System (PDC), Wideband Local Area Network (WLAN), Local Area Network (LAN), a satellite communication system, automatic information system (AIS), and Mobitex and by passing through a network using TCP/IP.

Although not illustrated, a system server may be included and the system server may be communicated with other terminals included in the system through any appropriate wired or wireless technologies.

The system server controls storing of container identification information, tracking information, and door events, control according to the stored information, connection of the body module 141 with any additional peripheral devices, and storage of necessary information.

The body module 141 according to the current embodiment may be used not only to check opening/closing of the container door but also to selectively block a physical attempt to open and close the container door by connecting with a physical locking device of the container door.

Also, the container security device according to the present invention is attached to a part where the container door and the container wall are in contact. That is, the container security system is attached for the switch sensor to be located near the container door and the container wall.

(Container Security System)

The container security system according to the present invention may process seal information, cargo state information, base passing information, and location tracking information in real-time from a gate-out process from a shipper (POA) to a gate-in process to a consignee (POD).

Accordingly, the container security system includes the “container security device” for collecting information about container security and a cargo state and transmitting the information.

The “container security device” includes a means for sensing opening/closing (a seal state) of the container door, a means for sensing a cargo state, a means for sensing inside of the container, and a communication means for transmitting and receiving collected information.

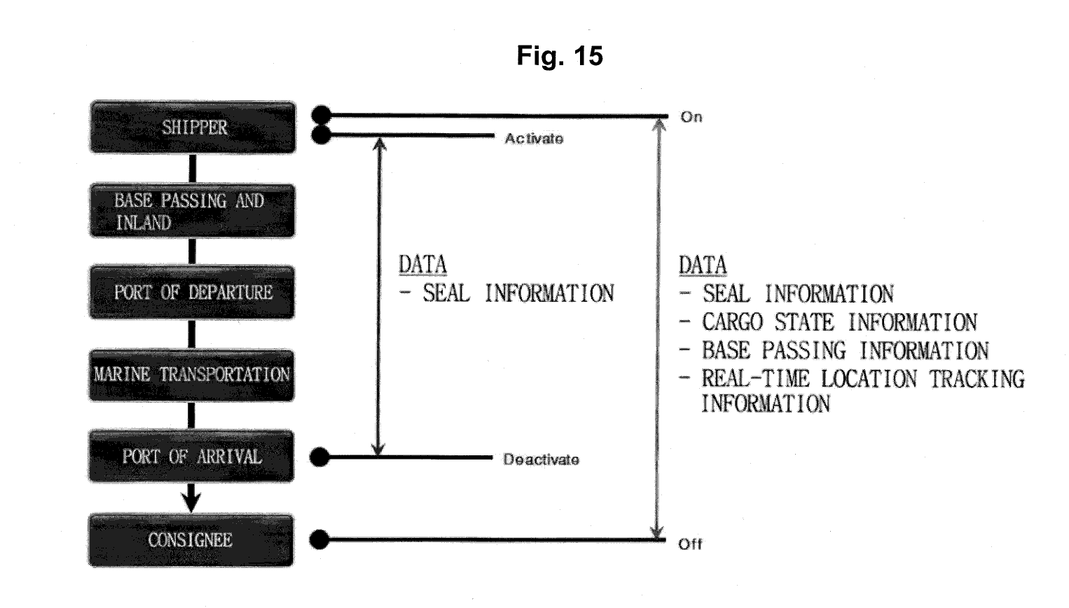

A container cargo transportation process using the container security system according to the present invention is described with reference to FIG. 15.

The cargo transportation process may include: shipper (POA), container security device attachment->main base passing and inland transportation->port of departure (ITP)->marine transportation->port of arrival (TTP), inland transportation to destination->consignee (POD).

Such a transportation process is an example using the container and may be performed in another form.

In a process of attaching the container security device, the container security device including a first communication means (security device), which communicates with a 433 MHz channel or a 2.4 GHz channel, provides information about container seal, a cargo state, and base passing, stores DB through a container transportation management server, and provide a transportation management service, and a second communication means (Ad-hoc module), which provides cargo state information during inland transportation in real-time (CDMA), provides DB storage through a container transportation management server and a service, and provides cargo state information in a yard/ship, may be attached to the container.

Here, the first and second communication means in the container security device may be formed by separate modules or may be integrated into one device.

In the container security system according to the present invention, a fixed reader and a mobile reader are arranged at each set base and mobile equipments are installed to the set base.

Base positioned equipments may include readers such as a 433 MHz Fixed-Reader, a 2.4 GHz Fixed-Reader, a Hand Held safe-Reader (HHR), and base mobile equipments may include a 433 MHz relay device, a 2.4 GHz relay device, a network device (Coordination-Point) which receives information about Ad-hoc modules, and a network bridge.

The container security system according to the present invention receives information provided by the security device and the Ad-hoc modules through the base positioned equipments and the base mobile equipments so as to store the information through each local server at transportation bases and the container transportation management server and to provide a transportation management service.

In the present invention, the base positioned equipments and the base mobile equipments may be installed as follows in order to manage container seal information, cargo state information, base passing information, and real-time location tracking information through the security device and the Ad-hoc module.

First, for the shipper (POA) process, a reader, a 433 MHz relay device, a 2.4 GHz relay device, and a network device (Coordination-Point), which receives information about Ad-hoc modules, are installed to an exit gate of a warehouse.

Also, for the base passing and inland transportation processes, readers are installed at each base.

For a port of departure (ITP) process, a reader is installed to an entrance gate and a 433 MHz relay device, a 2.4 GHz relay device, a network device (Coordination-Point), which receives information about Ad-hoc modules, and a network bridge are installed.

For the marine transportation process, the network device (Coordination-Point) for shipping is installed.

For the port of arrival (TTP) process, a 433 MHz relay device and a 2.4 GHz relay device are arranged and a reader is installed to an exit gate.

For the consignee (POD) process, a reader is installed to an entrance gate of a warehouse and a 433 MHz relay device and a 2.4 GHz relay device are arranged.

The entire system, in which the base positioned equipments and the base mobile equipments are installed for receiving information provided by the security device and the Ad-hoc module, is as follows.

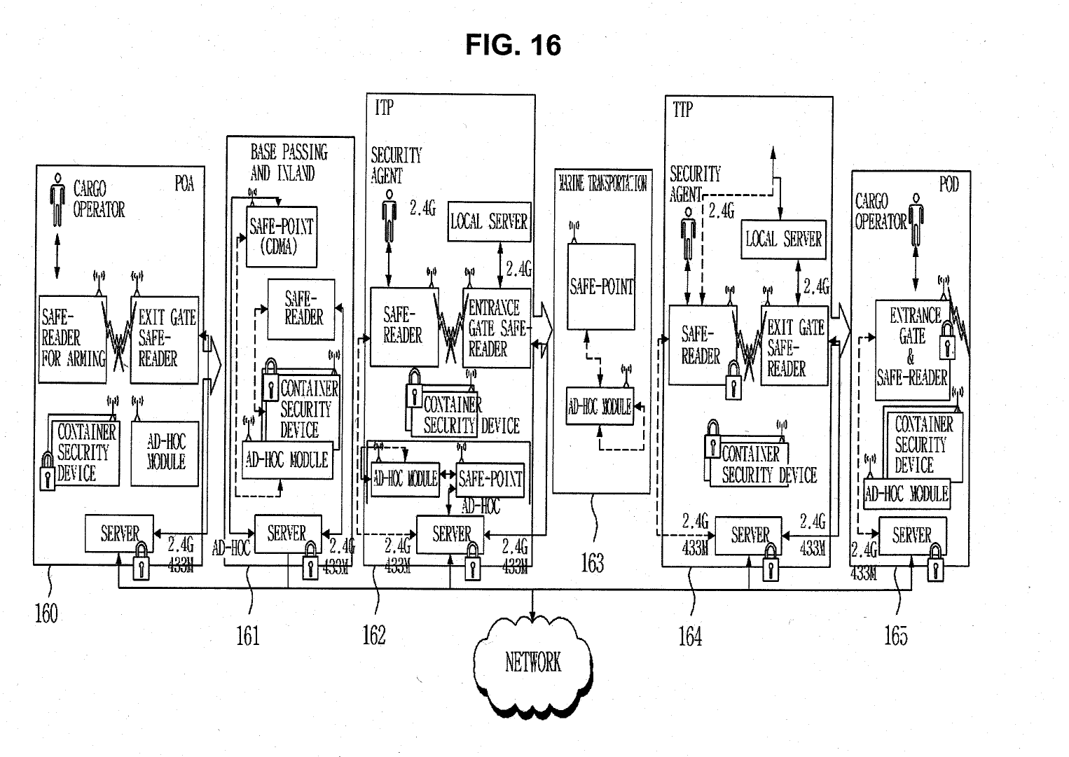

FIG. 16 is a view of the container security system in each transportation process, according to an embodiment of the present invention.

In a shipper process in operation 160, container seal information, cargo state information, and base passing information provided from the security device attached to the container and the Ad-hoc module are collected through the reader installed to the exit gate of the warehouse, the 433 MHz relay device, and the 2.4 GHz relay device and are transmitted to the container transportation management server, which is connected to a container transportation management network so as to manage container transportation information and provide a transportation management service.

The information collected by the reader installed to the exit gate of the warehouse is provided to the container transportation management server connected to a network through a local server.

In a base passing and inland transportation process in operation 161, container seal information, cargo state information, and base passing information provided from the security device attached to the container and the Ad-hoc module are collected through the reader installed at the base and the network device (Coordination-Point) and are transmitted to the container transportation management server, which is connected to the container transportation management network so as to manage container transportation information and provide a transportation management service.

In a port of departure (ITP) process in operation 162, container seal information, cargo state information, and base passing information provided from the security device attached to the container and the Ad-hoc module are collected through the network device (Coordination-Point) for vehicles, the reader installed to the entrance gate, the 433 MHz relay device, and the 2.4 GHz relay device and are transmitted to the container transportation management server.

In a marine transportation process in operation 163, container seal information, cargo state information, and location information are collected by the Ad-hoc module for providing state information in a yard/shipping and the network device (Coordination-Point) for shipping.

In a port of arrival (TTP) process in operation 164, container seal information, cargo state information, and location information provided from the security device attached to the container are collected trough the reader installed to the exit gate, the 433 MHz relay device, and the 2.4 GHz relay device and are transmitted to the container transportation management server.

In a consignee (POD) process in operation 165, container seal information, cargo state information, and base passing information provided from the security device attached to the container and the Ad-hoc module are collected through the reader installed to the entrance gate, the 433 MHz relay device, and the 2.4 GHz relay device and are transmitted to the container transportation management server.

(Container Security Management Method)

A container security management method using the container security system according to the present invention may include a shipper process, an inland transportation process, a port of departure process, a marine transportation process, a port of arrival process, and a consignee process.

The shipper process, a container security system activating process, and a container security system sealing process are described in more detail as follows.

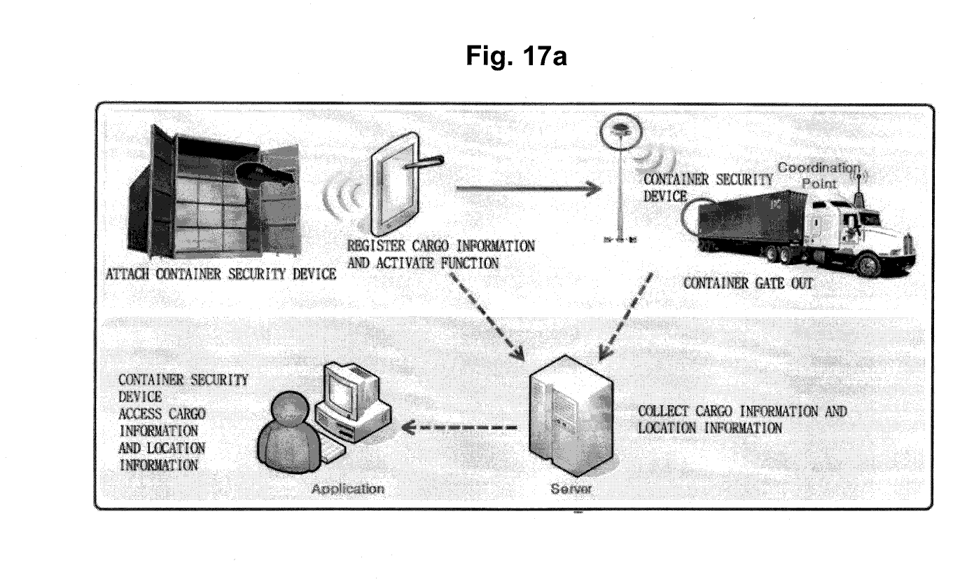

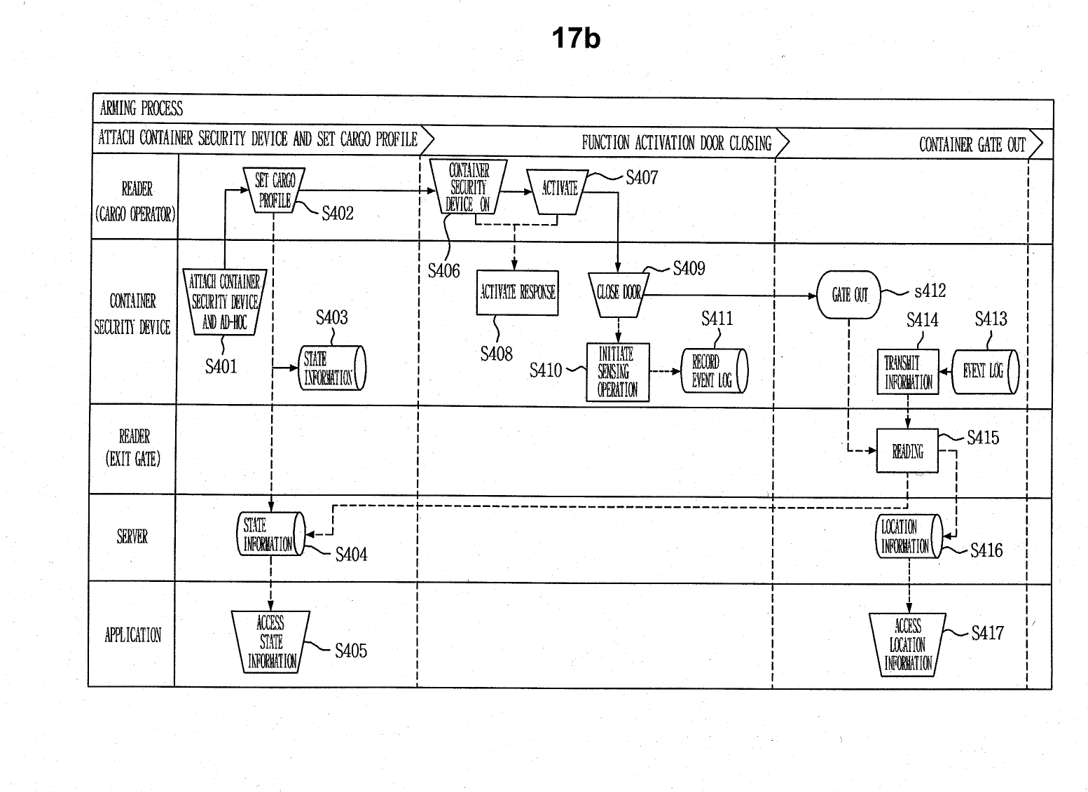

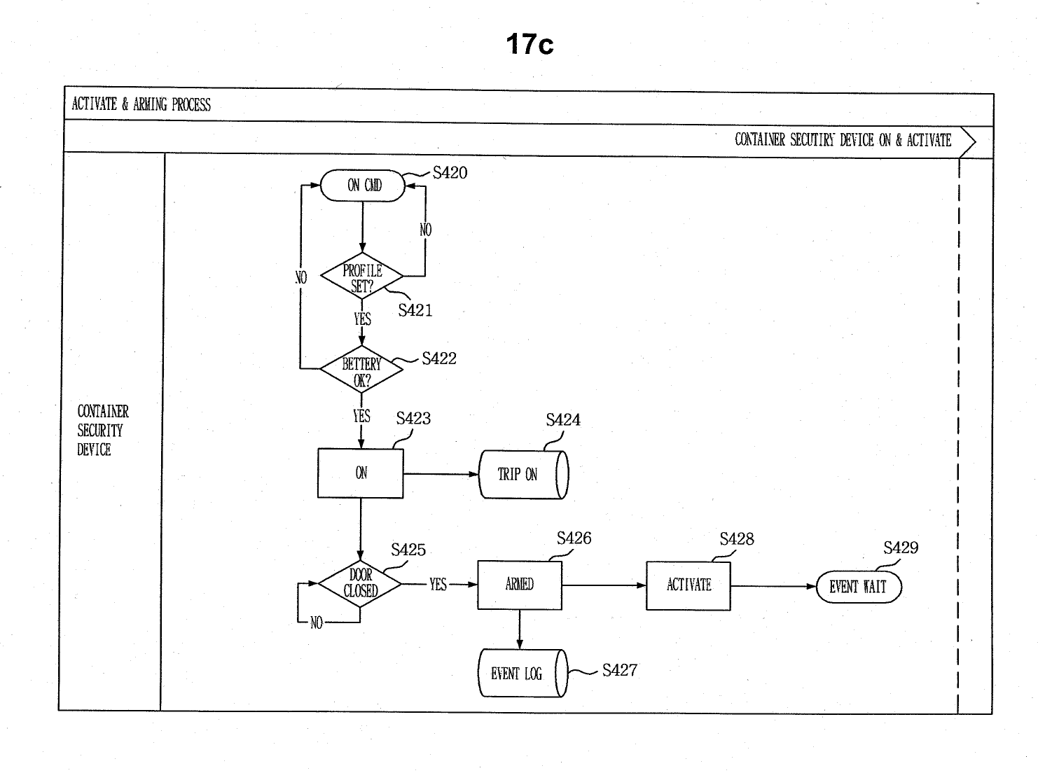

FIG. 17A illustrates the shipper process in the container security system, according to the present invention and FIG. 17B is a flowchart illustrating the shipper process in the container security system, according to the present invention.

FIG. 17C is a flowchart illustrating the container security system activating and sealing process.

In the shipper process as in FIG. 17A, cargo is loaded into the container, the security device and the Ad-hoc module are attached to the container, cargo profile is generated through the reader, the security device is activated, information is registered to DB, and the container is delivered.

The container information and location information are collected by the container security device and the information is accessed by an application.

More specifically, the shipper process includes a security device attaching and cargo profile inputting process, a function activation and container door closing process, and a container delivering process, as illustrated in FIG. 17b.

In the security device attaching and cargo profile inputting process, the security device and the Ad-hoc module are attached to the container, in operation S401, after the cargo is loaded into the container, and the cargo profile is input through the reader, in operation S402.

Such state information is transmitted to the security device, in operation S403, and the server in operation and is accessed by an application of the container security system according to the present invention, in operation S405.

In the function activation and container door closing process, the security device is turned on, in operation S406, and is activated, in operation S407. When a response of the security device is activated, in operation S408, the container door is closed, in operation S409.

When the container door is closed, a sensing operation is initiated, in operation S410, and an event log is recorded, in operation S411.

In the container delivering process, gate-out is accomplished, in operation S412, while the container door is closed and the sensing operation is performed, and the event log is read by the security device, in operation S413, to transmit the read information to the reader, in operation S414.

The reader reads the information, in operation S415, and state information and location information are transmitted to the server, in operations S404 and S416.

The state information and location information transmitted to the server are accessed by the application of the container security system according to the present invention, in operations S405 and S417.

In the activating and sealing process for the container security system according to the present invention, when a command for turning on the security device is input, in operation S420, whether the cargo profile is set is determined, in operation S421.

When the cargo profile is set, a residual quantity of a battery is checked, in operation S422.

When the cargo profile is set and the residual quantity of a battery is checked, the security device is activated, in operation S423, and the security device is tripped on DB, in operation S424.

Here, when closing of the container door is sensed, in operation S425, a container security sensing operation is initiated, in operation S426, and an even log is recorded, in operation S427.

While the security device is activated, in operation S428, an event wait state is set, in operation S429.

More specifically, the inland transportation process and the base passing process are described in more detail as follows.

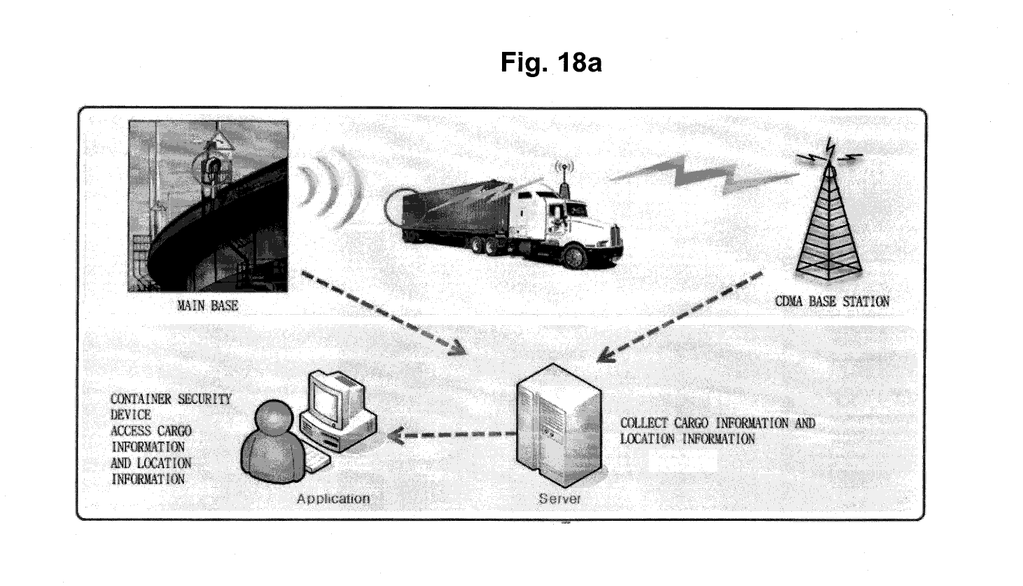

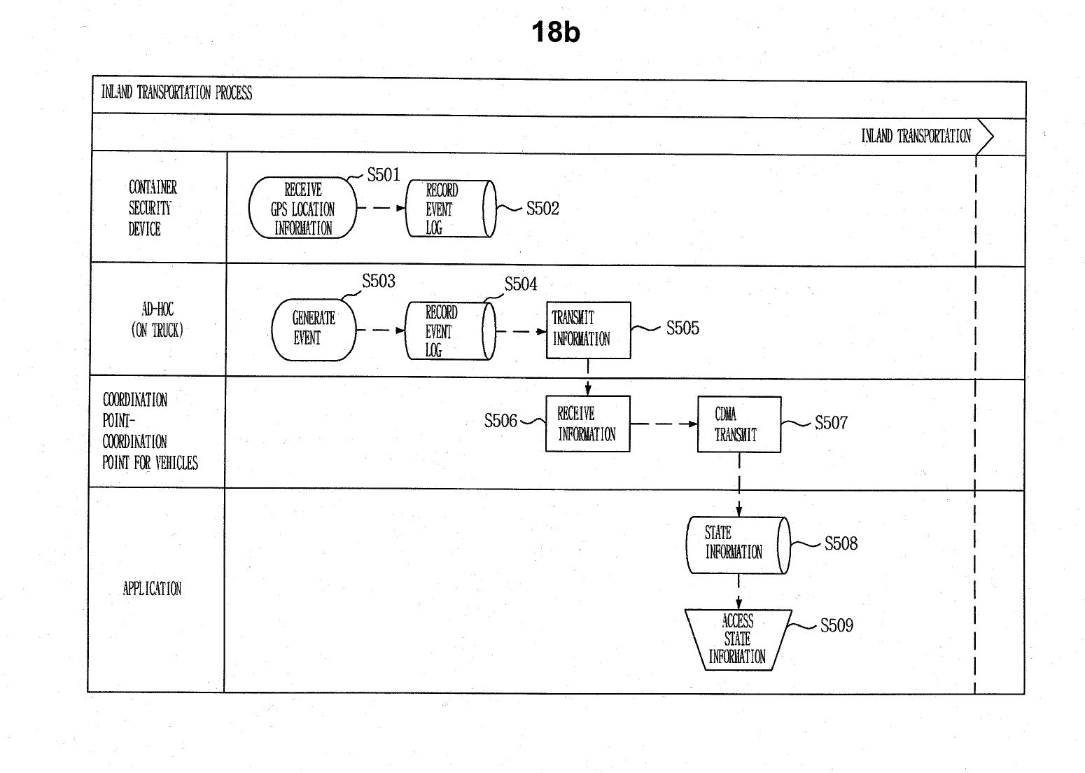

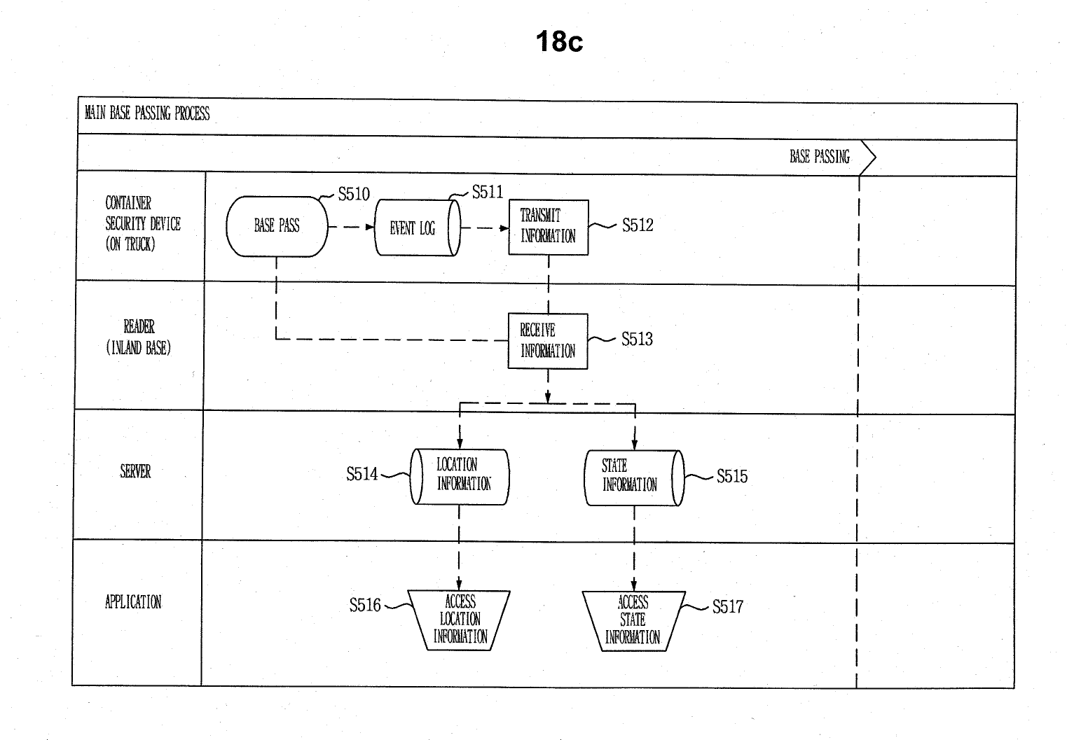

FIG. 18A illustrates the inland transportation process in the container security system, according to the present invention and FIG. 18B is a flowchart illustrating the inland transportation process in the container security system, according to the present invention.

FIG. 18C is a flowchart illustrating the main base passing process in the container security system, according to the present invention.

In the inland transportation process and the base passing process as in FIG. 18A, container seal information and cargo profile are identified by using the reader installed to the main base and cargo state and location information are transmitted through the Ad-hoc module in real-time.

More specifically, in the inland transportation process, when an event is generated during the inland transportation, GPS location information is received in the container security device, in operation S501, and an event log information is recorded, in operation S502, as illustrated in FIG. 18B.

When an event is generated, in operation S503, log information about generation of the event is recorded in the Ad-hoc module, in operation S504. Then, the corresponding information is transmitted through the Ad-hoc module, in operation S505. The information is received in the network device (Coordination-Point) for vehicles, in operation S506, and is transmitted by CDMA, in operation S507.

Such state information is transmitted to and stored in the server, in operation S508, and is accessed by the application of the container security system according to the present invention, in operation S509.

In addition, in the main base passing process, when base passing is accomplished, in operation S510, such information is transmitted to the reader installed to the base from the security device, an event log record is read, in operation S511, and the information is transmitted to the reader installed to the base from the security device, in operation S512, as illustrated in FIG. 18C.

Location information and state information received in the reader installed to the base, in operation S513, is transmitted to and stored in the server, in operations S514 and S515, and the location information and the state information are accessed through the application of the container security system according to the present invention, in operations S516 and S517.

The port of departure process, a container security system inspecting process, and an Ad-hoc process are described in more details as follows.

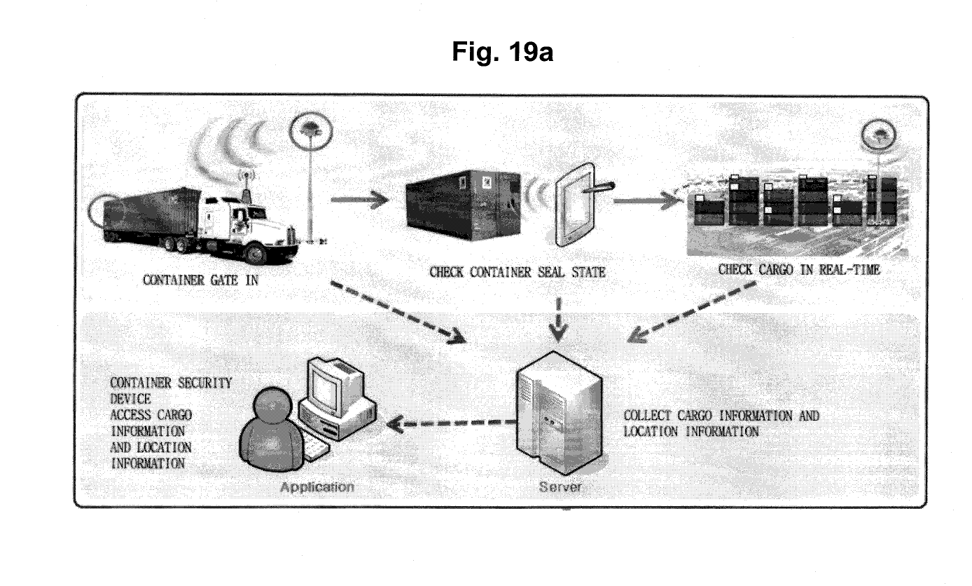

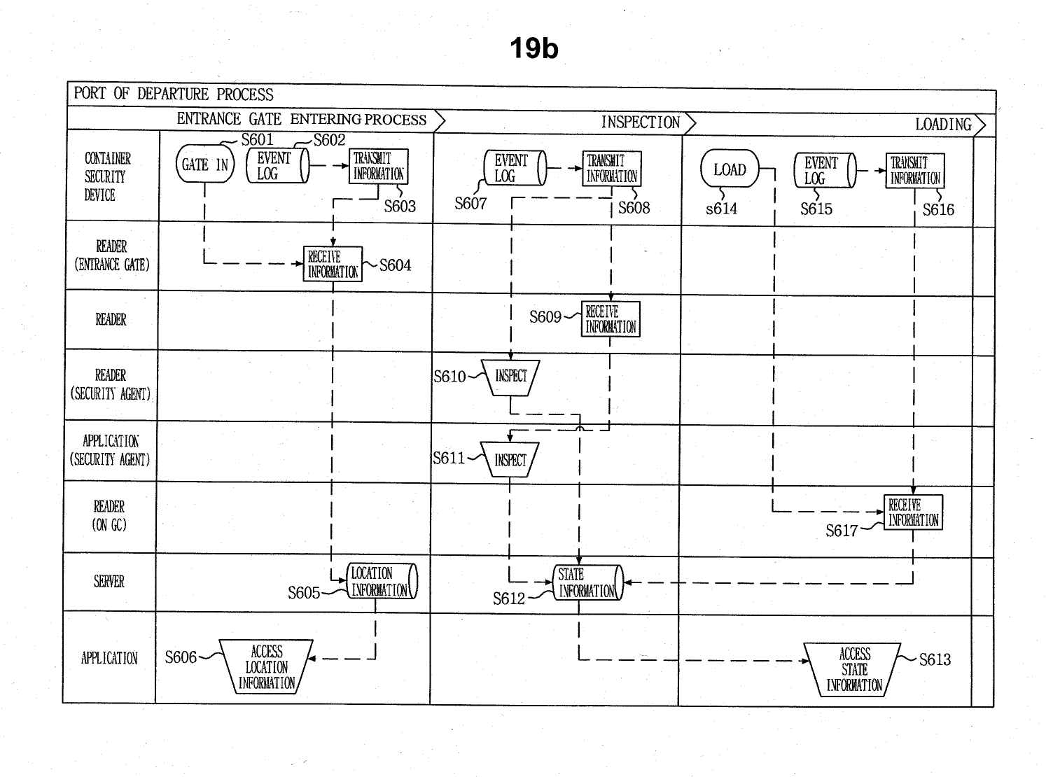

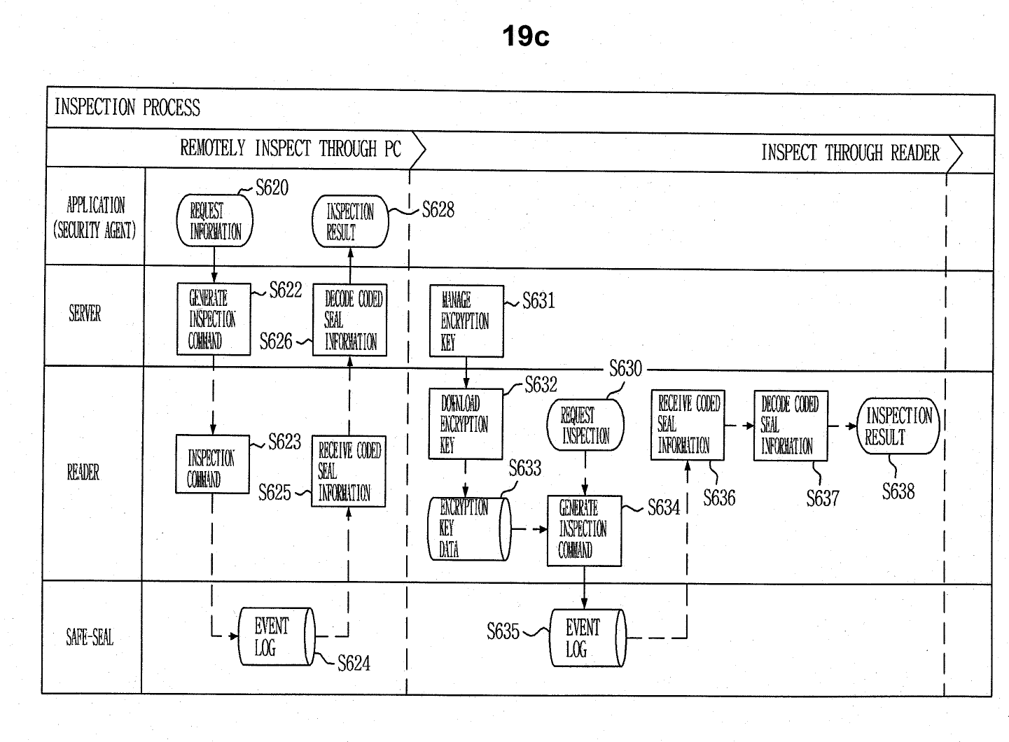

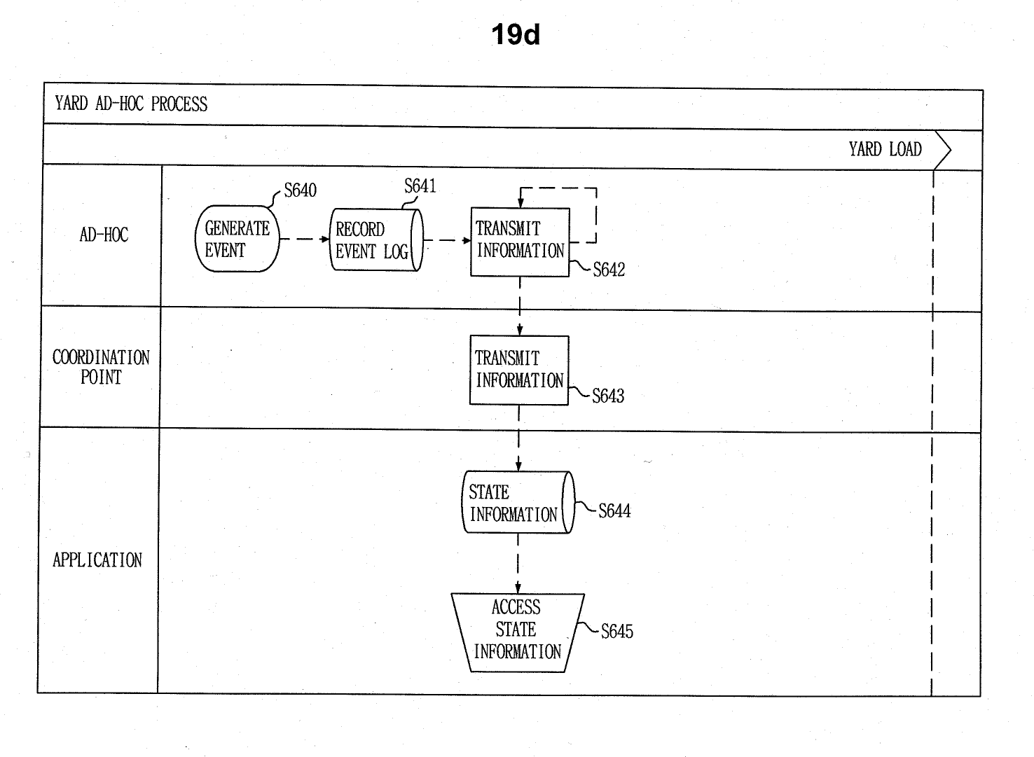

FIG. 19A illustrates the port of departure process in the container security system, according to an embodiment of the present invention and FIG. 19B is a flowchart illustrating the port of departure process in the container security system, according to an embodiment of the present invention.

In the port of departure process as in FIG. 19A, container seal information, cargo state information, yard loading, and shipping are checked through the reader and cargo state information in a yard is transmitted through the Ad-hoc module in real-time.

More specifically, the port of departure process includes an entrance gate entering process, an inspecting process, and a loading process as illustrated in FIG. 19B.

In the entrance gate entering process, when gate-in is accomplished, in operation S601, such information is transmitted from the security device to the reader installed to the gate, an event log record is read, in operation S602, and the information is transmitted from the security device to the reader installed to the gate, in operation S603.

The location information received from the reader, in operation S604, is transmitted to the server, in operation S605, and is accessed by the application of the container security system according to the present invention, in operation S606.

In the inspecting process for the security device, an event log record is read, in operation S607, the information is transmitted from the security device to the reader installed to the base, in operation S608, the transmitted information is read in the reader, in operation S609, and the read information is inspected in a security agent, in operations S610 and S611.

The state information received in the reader installed to the base is transmitted to the server, in operation S612, after passing through the inspecting process, and the state information is accessed by the application of the container security system according to the present invention, in operation S613.

In the shipping process, when the shipping is accomplished, in operation S614, such information is transmitted from the security device to a GC reader, an event log record is read, in operation S615, and the information is transmitted from the security device to the GC reader, in operation S616. The location information received in the GC reader, in operation S616, is transmitted to the server.

The inspecting process for the security device may include inspection through a PC and inspection through a reader.

FIG. 19C is a flowchart illustrating the inspecting process in the container security system, according to an embodiment of the present invention.

More specifically, in the inspection through a PC, when a security agent requests an inspection through a PC, in operation S620, an inspection command is generated in the server, in operation S622, as illustrated in FIG. 19C.

When the inspection command is transmitted from the reader to the security device, in operation S623, event log information is transmitted from the security device to the reader, in operation S624, and coded seal information is received in the reader, in operation S625.

The coded seal information is decoded in the server, in operation S626, and the decoded information is transmitted to the security agent PC, in operation S628.

In the inspection through the reader, an encryption key managed in the server, in operation S631, is downloaded from the reader, in operation S632, and encryption key data is read from the reader, in operation S633, so as to generate an inspection command, in operation S634.

Event log information is transmitted from the security device to the reader due to the generated inspection command, in operation S635.

The coded seal information is received in the reader, in operation S636, the coded seal information is decoded, in operation S637, and an inspection result is output, in operation S638.

The Ad-hoc process in a yard is described as follows.

FIG. 19D is a flowchart illustrating the Ad-hoc process in a yard. First, when an event is generated in the yard, in operation S640, an event log is recorded, in operation S641, and the information is transmitted from the Ad-hoc module to the network device (Coordination-Point), in operation S642.

Such state information received in the network device (Coordination-Point), in operation S643, is transmitted to the server, in operation S644, and is accessed by the application of the container security system according to the present invention, in operation S645.

Hereinafter, a marine transportation process in the container security system according to an embodiment of the present invention will be described.

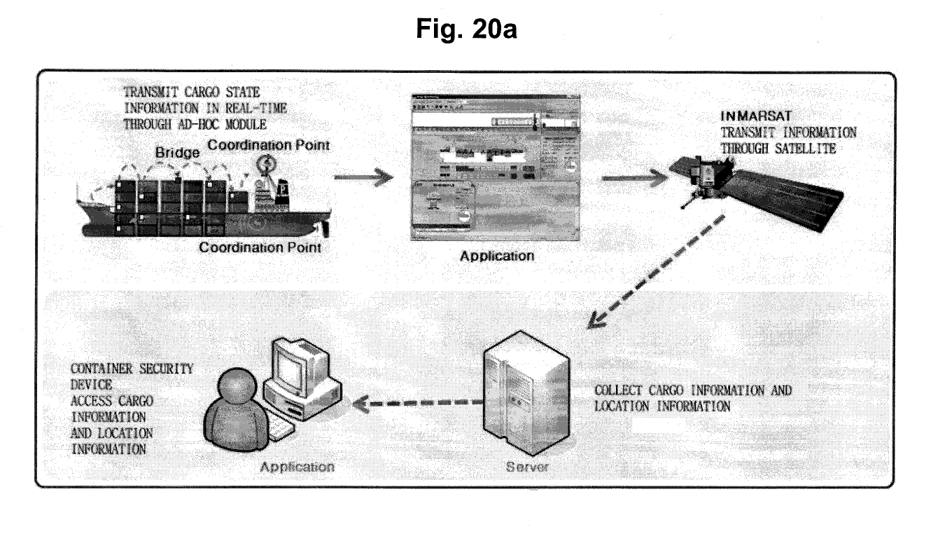

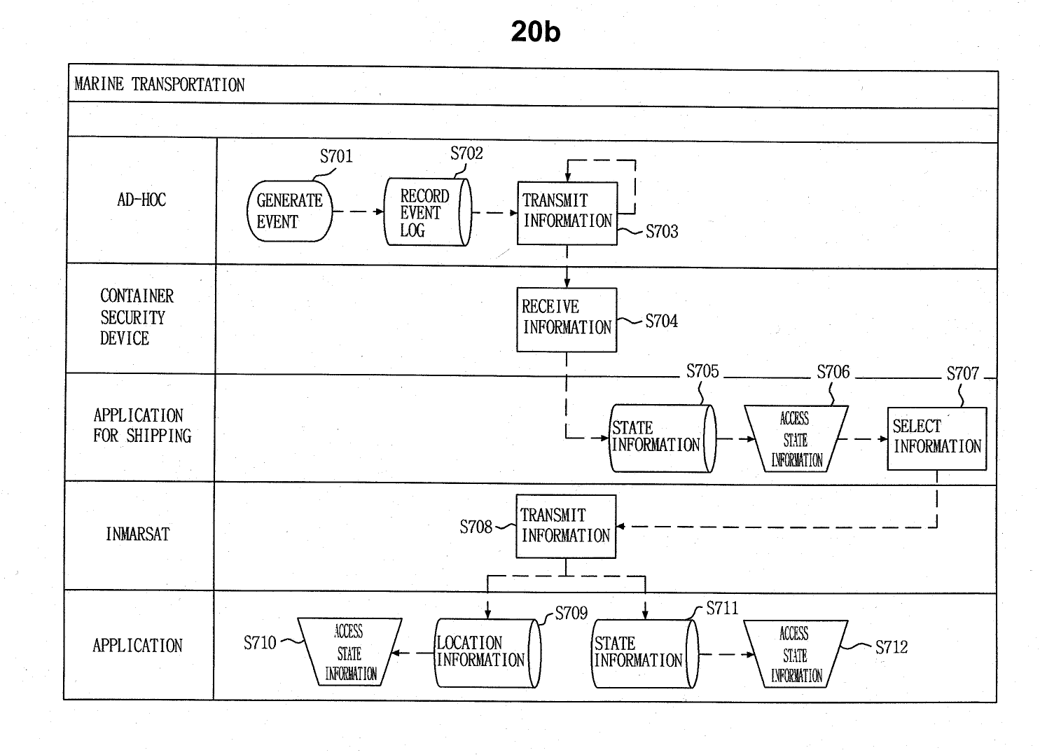

FIGS. 20A and 20B illustrate the marine transportation process in the container security system, according to an embodiment of the present invention and is a flowchart illustrating the marine transportation process, respectively.

In the marine transportation process as in FIG. 20A, cargo state information is transmitted in real-time by using the Ad-hoc module and the information is transmitted by using satellite so that cargo profile and seal information are collected through the container security device.

As in FIG. 20B, when an event is generated during the marine transportation, in operation S701, an event log is recorded, in operation S702, and the corresponding information is transmitted from the Ad-hoc module, in operation S703.

The information transmitted by the Ad-hoc module is received in the container security device, in operation S704, the state information is recorded through an application for shipping, in operation S705, and the state information is accessed, in operation S706.

If information is selected, in operation S707, the selected information is transmitted through a satellite (INMARSAT), in operation S708.

The location information, in operation S709, and the state information, in operation S711, are transmitted to the server and the transmitted location information and state information are accessed by the application of the container security system according to the present invention, in operations S710 and S712.

Hereinafter, the port of arrival process in the container security system according to an embodiment of the present invention will be described.

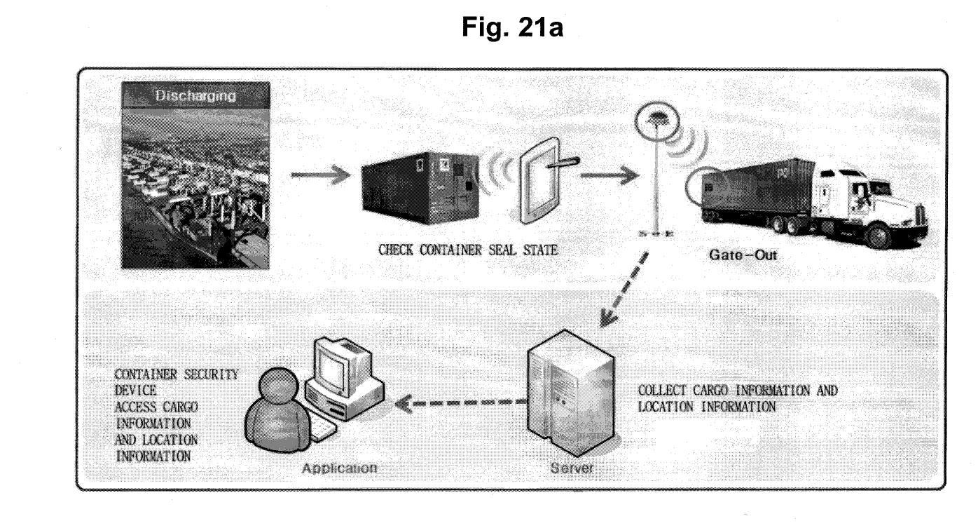

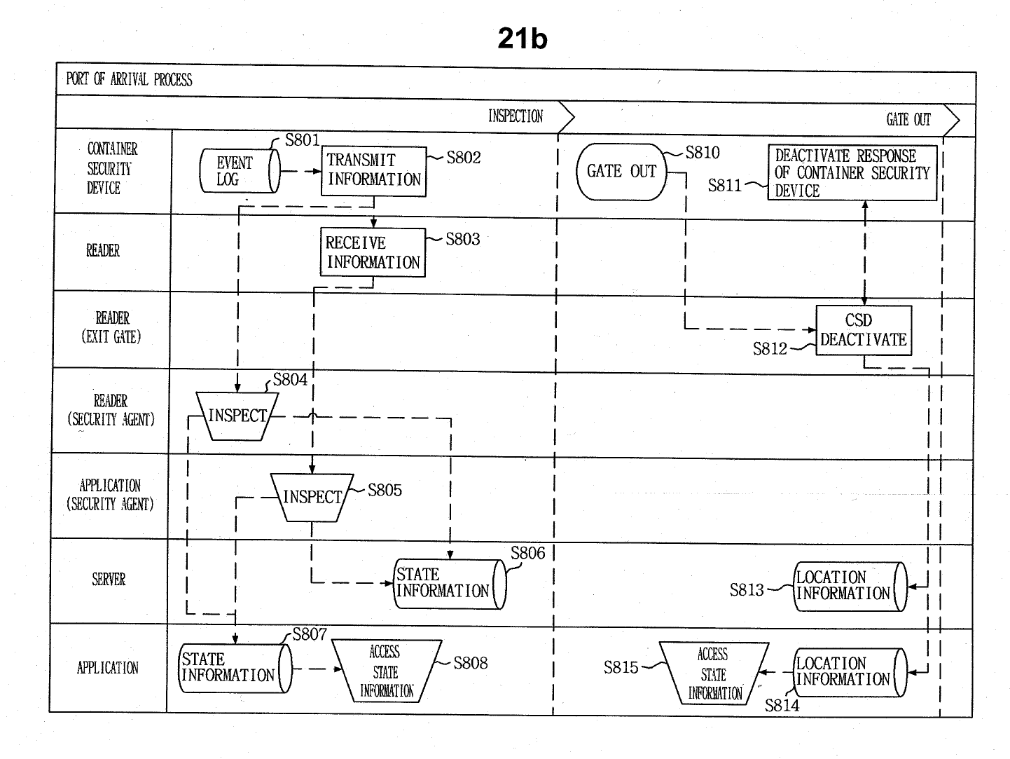

FIGS. 21A and 21B illustrate the port of arrival process in the container security system, according to an embodiment of the present invention and is a flowchart illustrating the port of arrival process, respectively.

The port of arrival process as in FIG. 21A includes checking a container seal state through the reader, deactivating a container security function, and total inspection or a gate-out process.

In order to check the container seal state, the container security device is inspected.

In the inspection process, an event log record, in operation S801, is read in the security device, in operation S802, the read information is transmitted to the reader installed to the base, in operation 803, and the information is transmitted to the reader of the security agent and is inspected, in operation S804, as illustrated in FIG. 21B.

The state information received in the reader installed to the base, in operation S803, is transmitted to the server, in operation S806, and is provided to a PC of the security agent so as to be inspected, in operation S805. The inspected information is accessed by the application of the container security system according to the present invention, in operations S807 and S808.

In the deactivating of the container security device due to the gate-out, when the gate-out is accomplished, in operation S810, such information is transmitted from the container security device to the reader installed to the gate and a response of the container security device is deactivated, in operation S811 according to a deactivation request for the container security device, in operation S812.

After the response of the container security device is deactivated, container location information is transmitted to the server, in operation S813, and is accessed by the application of the container security system according to an embodiment of the present invention, in operation S814.

Hereinafter, the consignee process in the container security system according to an embodiment of the present invention will be described.

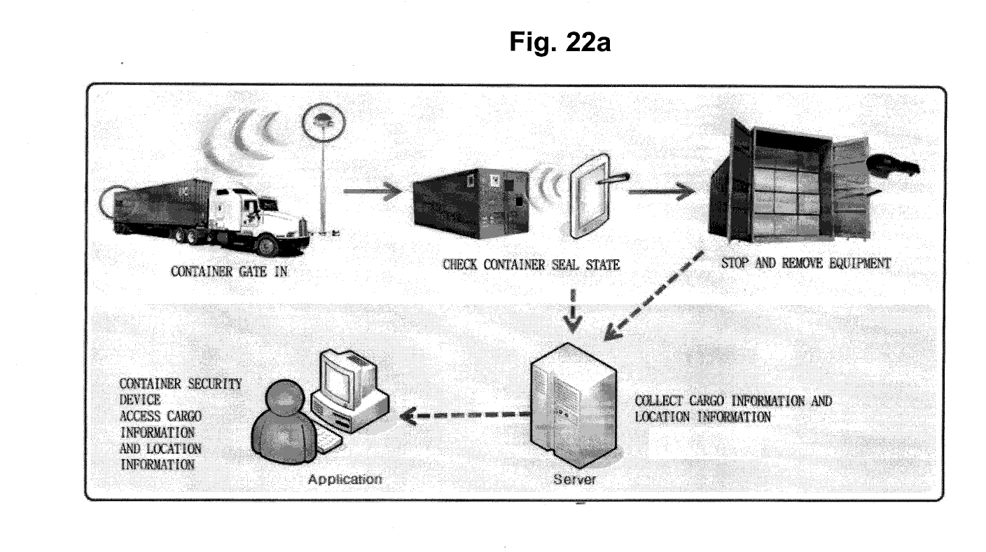

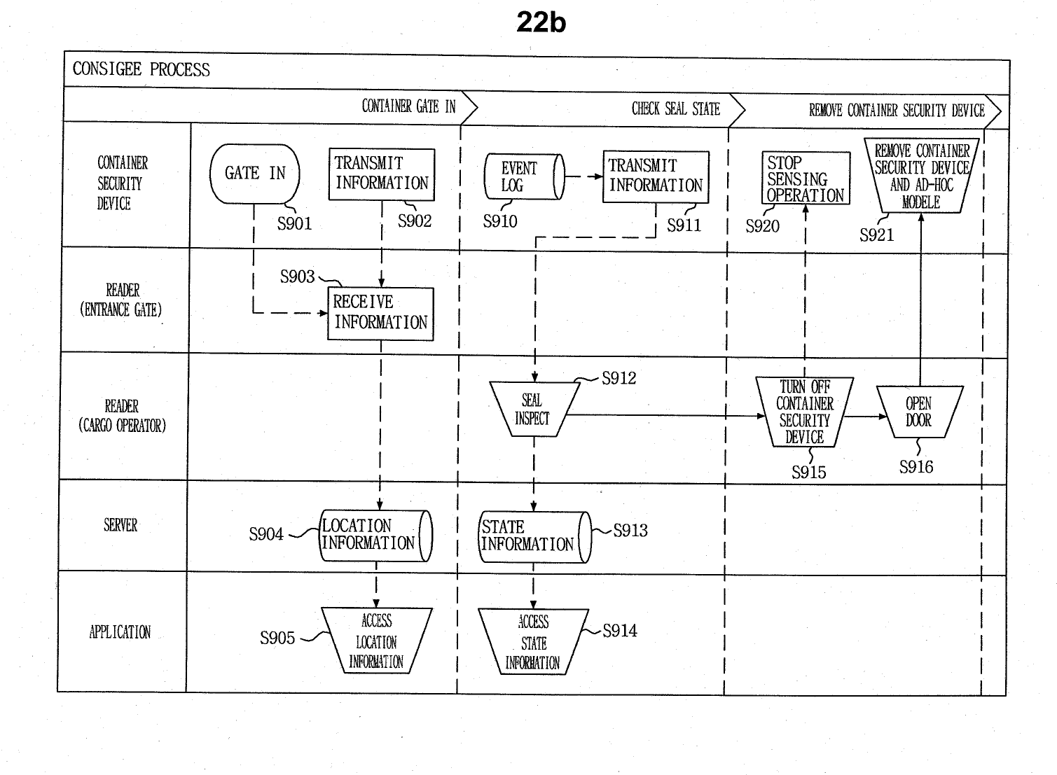

FIGS. 22A and 22B illustrate the consignee process in the container security system, according to an embodiment of the present invention and is a flowchart illustrating the consignee process, respectively.

In the consignee process as in FIG. 22A, container seal and cargo state are checked by using the reader, when the container is entered, the container security device is turned off, and the container security device is removed from the container.

The consignee process includes a container entering process, a seal state checking process, and a container security device removing process as illustrated in FIG. 22B.

In the container entering process, when the container is entered, in operation S901, the corresponding information is transmitted from the container security device, in operation S902, and is received in the reader installed to the entrance gate, in operation S903.

The received information is transmitted to the server, in operation S904, and is accessed through the application of the container security system according to the present invention, in operation S905.

In the seal state checking process, log information is read in the container security device, in operation S910, and is transmitted to the reader, in operation S911. Then, a seal inspection is performed by the security agent based on the information received in the reader, in operation S912.

The state information after the seal inspection is transmitted to the server, in operation S913, and is accessed through the application of the container security system according to the present invention, in operation S914.

According to the result of seal inspection, an off command is sent from the reader, in operation S915, and a sensing operation of the container security device is stopped, in operation S920. When the container door is opened, in operation S916, the container security device and the Ad-hoc module are removed, in operation S921.

In the container security management method described above according to the present invention, the seal information, the cargo state information, the base passing information, and location tracking information may processed in real-time from a gate-out process from the shipper (POA) to a gate-in process to the consignee (POD).

In particular, the container security device, the container security system, and the security management method according to the present invention strengthen not only safety of cargo but also characteristics of tracking state/location of cargo and thus satisfy the standards required by each country so as to accomplish rapid customs and to expand goods for transportation. In addition, the Ad-hoc module is applied so as to provide a state of cargo in ground transportation and in a yard/ship in real-time.

The container security device, the container security system, and the security management method according to the present invention have following effects.

First, the container security device is installed to the inside of the container so as to directly sense opening/closing of the container door.

Second, the container security device may not be affected by a change of container sizes, may be resistant from an external shock, and may smoothly communicate with the outside regardless of a loading environment and a container structure.

Third, the body module may be fixed inside of the container and the antenna for a wireless communication is positioned outside of the container so that the container security device may efficiently check opening/closing of the container door and an opening/closing record of the container door.

Fourth, the antenna for a wireless communication is positioned outside of the container so that the container security device may efficiently check opening/closing of the container door and an opening/closing record of the container door without affecting from the degree of communication network establishment while passing through various areas.

Fifth, the body module is fixed inside of the container so as to completely prevent a breakdown of the container security device caused by outsiders.

Sixth, the switch sensor is used to check opening/closing of the container door by using a change in the magnetic field occurring at the rotating shaft between the container wall and the container door so as to accurately sense the opening/closing of the container door.

Seventh, the magnets are used to detach the body module from the inside of the container and thus the body module may be recycled after use.

Eighth, the seal information, cargo state information, base passing information, and a location tracking information may processed in real-time from a gate-out process from a shipper (POA) to a gate-in process to the consignee so that reliability of cargo transportation may be increased.

Ninth, safety with respect to shock, loss, fire, and a change of temperature and humidity may be secured in all processes including the inland transportation process and the marine transportation process.

Tenth, the container security system and the security management method may satisfy a strengthened container security standard and various other container security standards each having different systems.

Eleventh, a rapid developed communication environment may be used by supporting 2.4 GHz/433 MHz dual band communication so as to increase speed and accuracy of container security information process.

Twelfth, characteristics of tracking state/location of cargo are strengthened so that the standards required by each country are satisfied so as to accomplish rapid customs and to expand goods for transportation.

Thirteenth, the Ad-hoc module is applied so as to provide a state of cargo in ground transportation and in a yard/ship in real-time.

While the present invention has been particularly shown and described with reference to exemplary embodiments thereof, it will be understood by those of ordinary skill in the art that various changes in form and details may be made therein without departing from the spirit and scope of the present invention as defined by the following claims.

1-33. (canceled)

34. A container security device comprising:
a body part installed at a junction of a wall of a container body and a container door;
a sliding part configured to slide in the body part by contacting with one of the container door and the container wall during opening and closing of the container door;
an elastic part which elastically couples the sliding part to the body part; and
a motion sensing means which senses movement of the sliding part.

35. The container security device of claim 34, wherein the body part is attached to one of the edge of the container door and the edge of the container body.

36. The container security device of claim 34, wherein the sliding part comprises a bar, in which one end thereof is supported by the elastic part and the other end thereof is configured to project outside the body part by a predetermined length, and slide along a sliding guide formed inside the body part.

37. The container security device of claim 36, wherein the motion sensing means is a micro switch which senses a plurality of hitch protrusions formed at one side of the bar using a hitch pin to sense movement of the sliding part.

38. The container security device of claim 34, wherein the motion sensing means senses sliding part movement in only one direction.

39. The container security device of claim 34, wherein the body part is closely adhered to the container door, and a shock sensor is included in the body part.

40. The container security device of claim 34, further including a temperature and humidity sensor in the body part.

41. A container security device comprising:
a body module comprising a sensor and a cable connection terminal, wherein the sensor is formed at one side of a body and is configured to sense a container state and the cable connection terminal is formed at the other side of the body; and
a connection cable comprising a body connection terminal and an antenna, wherein a body connection terminal is formed on one end of the connection cable for connecting with the cable connection terminal of the body module and the antenna is formed on the other side of the connection cable for communicating with the outside,
wherein the connection cable is configured to be located outside of the container so as to pass through the container door and the container wall, the body module is configured to be located inside of the container, and the antennal is configured to be located outside of the container.

42. The container security device of claim 41, wherein the sensor included in the body module is a switch sensor for sensing the opening and closing of the container door.

43. The container security device of claim 41, wherein the connection cable comprises a light emitting diode which turns on and off according to the opening and closing of the container door.

44. The container security device of claim 41, wherein the body module includes attaching means for attaching the body to the container wall.

45. The container security device of claim 41, wherein the body module includes a main board, and the main board includes an interface unit for interfacing with sensors, a microprocessor for controlling operations of the sensors and storing and transmitting information obtained according to the sensing result, a communication module for communicating with an external reader, a memory storing information about a container state and information about the time when the connection cable connected to the body module is not functioning, a power supplying unit supplying power to each element in the body module, and a timer for checking the opening and closing time of the container door.

46. The container security device of claim 45, wherein the sensors connected through the interface unit include a switch sensor for sensing the opening and closing of the container door and sensors for monitoring states in the container including at least one of temperature, vibration, radioactivity, gas detection, and movement.

47. A container security system comprising a container security device, wherein the container security device includes: a first communication means for providing container seal information through multi-channel communication; and a second communication means for providing information about container transportation and storage in real-time.

48. The container security system of claim 47, further including:
a container transportation management server which stores information provided from a container security device and provides a container transportation management service; and
base positioned equipment and base mobile equipment which receive information provided from the container security device and transmit the received information to the container transportation management server.

49. The container security system of claim 47, wherein the container security device provides container seal information, cargo state information, base passing information, and location tracking information in real-time from a gate-out process from a shipper process to a consignee process through the first and second communication means.

50. The container security system of claim 47, wherein the first communication means communicates with one of a 433 MHz channel and a 2.4 GHz channel and provides container seal information, cargo state information, and base passing information, and wherein the second communication means is an Ad-hoc module for providing cargo state information during inland transportation in real-time and in at least one of a ship and a shipyard.

51. A container security system comprising:
a security device which provides container seal information, cargo state information, and base passing information through multi-channel communication;
an Ad-hoc module which provides cargo state information during inland transportation in real-time and in at least one of a ship and a shipyard;
a container transportation management server which stores information provided from the security device and the Ad-hoc module and provides a container transportation management service; and
base positioned equipment and base mobile equipment which receive information provided from the container security device and the Ad-hoc module and transmit the received information to the container transportation management server.

52. The container security system of claim 51, wherein the container security device and the Ad-hoc module are attached to the container after cargo is loaded to the container in a shipper process and are removed from the container when the container is entered and the cargo state is checked in a consignee process.

53. The container security system of claim 51, wherein the container security device provides container seal information, cargo state information, and base passing information by using a at least one of a 433 MHz channel and a 2.4 GHz channel.

54. The container security system of claim 51, wherein the base positioned equipment includes a 433 MHz reader and a 2.4 GHz reader for communicating with the container security device and the base mobile equipment comprise a 433 MHz relay device, a 2.4 GHz relay device, a network device which receives information about Ad-hoc modules, and relay nodes of a network bridge.

55. A container security management method comprising:
attaching a container security device and an Ad-hoc module to a container in a shipper process where cargo is loaded to the container and delivered, wherein the container security device provides container seal information, cargo state information, and base passing information through multi-channel communication and the Ad-hoc module provides cargo state information in real-time during an inland transportation process and in shipyards and on ships, so as to provide container seal information, cargo state information, base passing information, and location tracking information in real-time from the shipper process to a consignees process.

56. The method of claim 55, wherein the shipper process includes attaching the container security device and the Ad-hoc module to the container after loading the cargo, generating a cargo profile through a reader, activating the container security device, registering information to DB, and delivering the container.

57. The method of claim 56, wherein the activating of the container security device includes:
determining whether the cargo profile is set due to a turning-on command of the container security device;
when the cargo profile is set, checking a residual charge of a battery;
activating a sealing function and tripping on DB;
when closing of the container door is sensed, initiating a container security sensing operation and recording an event log;
activating the container security device and setting an event wait state.

58. The method of claim 55, further including an inland transportation process performed between the shipper process and the consignee process, wherein the inland transportation process includes identifying container seal information and a cargo profile through a fixed reader installed to a main base of a inland transportation path and transmitting a cargo state and location information through the Ad-hoc module in real-time.

59. The method of claim 58, wherein when an event is generated during the inland transportation, the inland transportation includes:
recording log information for the event and transmitting the corresponding information through the Ad-hoc module;
receiving the transmitted information in a network device and transmitting the received information by code division multiple access;
receiving state information transmitted by code division multiple access in an operating server and accessing the state information through an application of the container security system.

60. The method of claim 58, wherein when base passing is accomplished during the inland transportation, the inland transportation includes:
transmitting base passing information from the container security device to a reader installed to the base;
reading an event log and transmitting the read event log from the container security device to the reader installed to the base; and
transmitting location information and state information received in the reader to the operating server,
wherein the location information and the state information received in the operating server are accessed by an application of the container security system.

61. The method of claim 55, further including an a port of departure process performed between the shipper process and the consignee process, wherein the port of departure process includes inspecting container seal and cargo state through the reader, checking yard loading and shipping, and transmitting cargo state information in the yard by using the Ad-hoc module.

62. The method of claim 61, wherein when a security agent requests an inspection through a PC in the inspecting of the container seal and the cargo state, the inspecting of the container seal and the cargo state includes:
requesting a container transportation management server to generate an inspection command;
generating the inspection command in the operating server in response to the request;
when the inspection command is transmitted from the reader to the container security device, transmitting event log information from the container security device to the reader and receiving coded seal information in the reader;
decoding the coded seal information in the operating server, transmitting the decoded information to the container transportation management server, and transmitting the received information to a security agent PC.

63. The method of claim 61, wherein when a security agent requests an inspection through the reader in the inspecting of the container seal and the cargo state, the inspecting of the container seal and the cargo state includes:
downloading an encryption key managed in the operating server from the reader;
reading encryption key data from the reader and generating an inspection command;
transmitting event log information from the container security device to the reader in response to the generated inspection command; and
receiving the coded seal information in the reader, decoding the coded seal information, and outputting an inspection result.

64. The method of claim 55, further including a marine transportation process performed between the shipper process and the consignee process, wherein the marine transportation process comprises:
in order to transmit cargo state information in real-time by using the Ad-hoc module, recording an event log, when an event is generated during the marine transportation, and transmitting the corresponding information from the Ad-hoc module;
receiving the information transmitted by the Ad-hoc module in a network device, recording state information through an application for shipping, and accessing the state information; and
transmitting selected information from the state information to the operating server through a satellite.

65. The method of claim 55, further including a port of arrival process performed after the shipper process, wherein the port of arrival process includes checking a container seal state through the reader, performing a total inspection, if there is a problem as a result of checking the state, or performing a gate-out process, if there is no problem, and deactivating a container security function.

66. The method of claim 55, wherein the consignee process includes checking container seal and cargo state, when the container is entered, turning off the container security device, and removing the container security device from the container.
